(19) United States
(12) Patent Application Publication
(10) Pub. No.: US 2025/0307352 A1
(43) Pub. Date: Oct. 2, 2025

(54) METHOD AND SYSTEMS FOR AUTOMATICALLY BUILDING ANALYTIC COMPUTERIZED ENSEMBLES FOR OUTLIER DETECTION

(71) Applicant: MINDBRIDGE ANALYTICS INC., OTTAWA (CA)

(72) Inventors: Rachel KIRKHAM, Chelmsford (GB); Robin GROSSET, Ottawa (CA)

(21) Appl. No.: 18/620,720

(22) Filed: Mar. 28, 2024

(51) Int. Cl. G06F 18/2113

(52) U.S. Cl. CPC G06F 18/2113

(57) ABSTRACT

A method and apparatus for automatic outlier detection in data sets are provided. An ensemble of outlier detection operations is generated by selecting particular features of the data set, selecting particular algorithms to process those features, and running the selected algorithms using the selected features to identify potential outliers. Feature selection and algorithm selection can be based on a variety of factors, such as measurements of correlation, information content, effectiveness and diversity. Information content may indicate the amount of information in a feature which is a candidate for selection, and may be measured using an information theoretic entropy or potential data compression rate. Diversity and correlation may measure the extent to which different features, algorithms, or combinations thereof produce different information or results.

### CROSS-REFERENCE TO RELATED APPLICATIONS

This is the first application filed for the present invention.

### FIELD OF THE INVENTION

The present invention pertains to the field of computerized data processing systems and associated methods, and in particular to methods and systems for outlier detection in structured data such as business ledgers.

### BACKGROUND

A frequently required but difficult task in data analysis is to process large amounts of data to identify items of interest. For example, in structured data such as business ledgers, forensic analysts, auditors, accountants or other investigators may be interested in finding indications of hidden errors, fraud or other irregularities. Automated data processing tools are available to assist with such tasks. However, to date such tools are mostly purpose-built and thus contain certain inflexibilities. Such a tool may therefore not be fully optimized in one or more respects for use in arbitrary new situations, such as searching for fraud in a particular business environment.

An example of the above is ensembles of artificial intelligence algorithms for auditing financial data. An ensemble employs multiple algorithms each of which processes data elements (e.g. corresponding to transactions in a ledger) in a different way for a different purpose. By combining the outputs of all algorithms in the ensemble, certain audit results can be achieved. By combining signals from multiple algorithms and more effective and robust system for detecting financial irregularities can be created. However, to date, ensembles of this type are of fixed design, including carefully selected and configured algorithms. This fixed design is a limiting factor in their applicability and, potentially, in their performance.

Therefore, there is a need for methods and systems for automatically building analytic ensembles of computerized tools that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method, apparatus and system for automatically generating ensembles of multiple analytic computational operations for identifying and detecting outliers of interest in data sets. The outliers can be data entries which are significant or anomalous in some way, for example as being indicative of fraud or some other notable circumstance of interest to an investigator. The analytic computer operations may involve selected ones of a set of pre-defined outlier detection operations, applied to selected data features. Features can be automatically or semi-automatically selected based on information content, correlations, or the like, or a combination thereof. Outlier detection operations can similarly be automatically or semi-automatically selected based on information content, correlations, or the like, or a combination thereof. Selections and ensemble generation can further utilize machine learning and user feedback.

According to an aspect of the present invention, there is provided a method implemented by a computing apparatus for identifying potential outlier data entries within a data set. The data set includes a plurality of data entries, each of the data entries comprising a value for some or all of a plurality of criteria. The method includes various operations performed automatically by the computing apparatus. The method may include receiving the data set. The method includes selecting a plurality of features of the data set to use within one or more outlier detection operations. Each of the features of the data set comprises or is derived from one or more of the criteria. The method includes selecting a plurality of outlier detection operations to generate an outlier characteristic metric for evaluating data entries within the data set. Each of the outlier detection operations includes an outlier detection algorithm being run using values of the data set corresponding to one of the selected features as input. The method includes generating, for each one of a set of data items and for each operation of the plurality of selected outlier detection operations, a respective outlier characteristic metric for said one of the data entries. The generating uses this operation applied to said one of the set of data items. Each one of the set of data items is a data entry or a set of associated data entries, e.g. associated with a same transaction. The method includes, for each one of the set of data items, combining the plurality of outlier characteristic metrics for said one of the set of data items to generate an ensemble outlier metric for said one of the data entries. The method may include outputting the outlier characteristic metrics, e.g. via a user interface or storage to memory.

In various embodiments, selecting the plurality of features of the data set to use within the outlier detection operations includes selecting a plurality of candidate features of the data set, each of the candidate features comprising or being derived from one or more of the criteria. The selecting may further include, for each of the candidate features, determining a respective information content metric representative of all values of data entries within the criteria of the candidate features. The selecting may further include selecting candidate features to be the features of the data set to use within the outlier detection operations at least partially using the information content metrics of the candidate features. The selecting the plurality of features of the data set to use within the outlier detection operations may further include: determining correlation between the candidate features prior to selecting the candidate features; and, if a correlation between two of the candidate features is above a predetermined threshold, inhibiting using both of the correlated candidate features.

The determining the information content metric for values of data entries within the criteria of the candidate feature may include determining a potential compression rate for the values of data entries within the criteria, wherein the information content metric is a (e.g. decreasing) function of the potential compression rate for the values of data entries within the criteria of the candidate feature.

The determining the information content metric for values of data entries within the criteria of the candidate feature may include using entropy (e.g. Shannon Entropy) calculations on the values of data entries within the criteria.

In some embodiments, selecting the plurality of outlier detection operations includes determining which of a plurality of candidate outlier detection algorithms can use the selected features. The selecting may further include running each of the candidate outlier detection algorithms with each of the selected features that can be used with the particular candidate outlier detection algorithm to generate candidate algorithm results. The selecting may further include determining an effectiveness metric for each of the candidate algorithm results, the effectiveness metric measuring the ability of the candidate algorithm results to separate data entries for outlier detection. The selecting may further include selecting the plurality of candidate outlier detection algorithms with specific features to use as the selected outlier detection operations based at least partially on the effectiveness metrics for the corresponding candidate algorithm results.

In some embodiments, the selecting the plurality of outlier detection operations includes determining a diversity metric for each of the candidate algorithm results relative to some or all other candidate algorithm results, the diversity metric measuring the correlation between information in the candidate algorithm results. The selecting the plurality of candidate outlier detection algorithms with specific features as the selected outlier detection operations may further be based at least partially on the diversity metrics for the candidate algorithm results relative to diversity metrics for other candidate algorithm results.

In some embodiments, the method includes applying a respective weighting to each of the outlier characteristic metrics during said combining. The weightings may be adjusted through machine learning, set according to manual input, or a combination thereof. The machine learning may operate to adjust the weightings responsive to feedback indicative of effectiveness of the outlier characteristic metrics, said effectiveness being effectiveness in identifying significant outliers.

In some embodiments, the method includes performing a machine learning operation to avoid selection of particular ones of the one or more outlier detection operations, said machine learning operation being responsive to feedback indicative of effectiveness of the outlier characteristic metrics, said effectiveness being effectiveness in identifying significant outliers.

In some embodiments, the method includes generating one or more features of the data set, prior to said selecting the plurality of features of the data set to use within the one or more outlier detection operations.

According to an aspect of the present invention, there is provided a computing apparatus for identifying potential outlier data entries within a data set. The computing apparatus includes a processing entity operable to receive a data set comprising a plurality of data entries. Each of the data entries includes a value for some or all of a plurality of criteria. The processing entity is operable to select a plurality of features of the data set to use within one or more outlier detection operations. Each of the features of the data set includes the values within the data entries for one or more of the criteria in the data set. The processing entity is operable to select a plurality of outlier detection operations to generate an outlier characteristic metric for evaluating data entries or ones of a set of data items of the data set. Each one of the set of data items is a data entry or a set of associated data entries. Each of the outlier detection operations includes an outlier detection algorithm being run with one of the selected features. The processing entity is operable to generate an outlier characteristic metric for each one of the set of data items using each of the plurality of selected outlier detection operations. The processing entity is operable to combine the plurality of outlier characteristic metrics for each one of the set of data items to generate an ensemble outlier metric for each of the data items.

Other embodiments of the above apparatus, commensurate with the above-described method, may also be provided for.

According to an aspect of the present invention, there is provided a (e.g. non-transitory) computer-readable medium containing a program element executable by a computing system to perform a method for identifying potential outlier data entries within a data set. The data set includes a plurality of data entries. Each of the data entries includes a value for some or all of a plurality of criteria. The computer-readable media may include program code for causing an apparatus to perform the method as described above. The computer-readable media may include first program code for selecting a plurality of features of the data set to use within one or more outlier detection operations, each of the features of the data set comprising the values within the data entries for one or more of the criteria in the data set. The computer-readable media may include second program code for selecting a plurality of outlier detection operations to generate an outlier characteristic metric for evaluating data entries within the data set, each of the outlier detection operations comprising an outlier detection algorithm being run with one of the selected features. The computer-readable media may include third program code for generating an outlier characteristic metric for each one of a set of data items using each of the plurality of selected outlier detection operations, wherein each one of the set of data items is one of the plurality of data entries or a set of associated ones of the plurality of data entries. The computer-readable media may include fourth program code for combining the plurality of outlier characteristic metrics for said each one of the set of data items to generate an ensemble outlier metric for said each one of the set of data items.

Other embodiments of the above computer-readable medium, commensurate with the above-described method, may also be provided for.

According to an aspect of the present invention, there is provided a method implemented by a computing apparatus for selecting features within a data set to use for outlier detection analysis. The data set includes a plurality of data entries, each of the data entries comprising a value for some or all of a plurality of criteria. The method includes various operations performed automatically by the computing apparatus. The method may include receiving the data set. The method includes selecting a plurality of candidate features of the data set, each of the candidate features comprising or being derived from one or more of the criteria. The method includes, for each candidate feature, determining an information content metric for values of data entries within the criteria of the candidate feature. The method includes selecting one or more of the candidate features to be the features within the data set to use for outlier detection analysis at least partially using the determined information content metrics. The method may include outputting results, e.g. via a user interface or storage to memory.

In some embodiments, the selecting the features within the data set to use for outlier detection analysis further includes: prior to selecting the one or more of the candidate features, determining one or more pairwise correlations between the candidate features; and, if one of the correlations, between two of the candidate features, is above a predetermined threshold, inhibiting using both of the candidate features associated with the one of the correlations.

In some embodiments, the determining the information content metric for values of data entries within the criteria of the candidate feature includes determining a potential compression rate for the values of data entries within the criteria. The information content metric is a (e.g. decreasing) function of the potential compression rate for the values of data entries within the criteria of the candidate feature.

In some embodiments, the determining the information content metric for values of data entries within the criteria of the candidate feature includes using entropy (e.g. Shannon Entropy) calculations on the values of data entries within the criteria.

In some embodiments, the method includes selecting a plurality of outlier detection operations to generate an outlier characteristic metric for evaluating data entries within the data set. Each of the outlier detection operations includes an outlier detection algorithm being run with one of the selected features. The method may further include generating an outlier characteristic metric for each one of a set of data items using each of the plurality of selected outlier detection operations, where each one of the set of data items is one of the plurality of data entries or a set of associated ones of the plurality of data entries. The method may further include combining the plurality of outlier characteristic metrics for said each one of the set of data items to generate an ensemble outlier metric for said each one of the set of data items.

In some embodiments, the selecting the plurality of outlier detection operations includes determining which of a plurality of candidate outlier detection algorithms can use the selected features. In some embodiments, the selecting includes running each of the candidate outlier detection algorithms with each of the selected features that can be used with the particular candidate outlier detection algorithm to generate candidate algorithm results. In some embodiments, the selecting includes determining an effectiveness metric for each of the candidate algorithm results. The effectiveness metric measures the ability of the candidate algorithm results to separate data entries for outlier detection. In some embodiments, the selecting includes selecting the plurality of candidate outlier detection algorithms with specific features to use as the selected outlier detection operations based at least partially on the effectiveness metrics for the corresponding candidate algorithm results.

In some embodiments, the selecting a plurality of outlier detection operations further includes: determining a diversity metric for each of the candidate algorithm results relative to all other candidate algorithm results. The diversity metric measures the correlation between information in the candidate algorithm results. The selecting the plurality of candidate outlier detection algorithms with specific features as the selected outlier detection operations may be further based at least partially on the diversity metrics for the candidate algorithm results relative to other candidate algorithm results.

According to an aspect of the present invention, there is provided a computing apparatus for selecting features within a data set to use for outlier detection analysis. The computing apparatus includes a processing entity operable to receive a data set comprising a plurality of data entries, each of the data entries comprising a value for some or all of a plurality of criteria. The processing entity is further operable to select a plurality of candidate features of the data set. Each of the candidate features comprises or is derived from one or more of the criteria. The processing entity is further operable to determine, for each candidate feature, an information content metric for values of data entries within the criteria of the candidate feature. The processing entity is further operable to select one or more of the candidate features to be the features within the data set to use for outlier detection analysis at least partially using the determined information content metrics.

Other embodiments of the above apparatus, commensurate with the above-described method, may also be provided for.

According to an aspect of the present invention, there is provided a (e.g. non-transitory) computer-readable medium containing a program element executable by a computing system to perform a method for selecting features within a data set to use for outlier detection analysis. The data set includes a plurality of data entries. Each of the data entries includes a value for some or all of a plurality of criteria. The computer-readable media may include program code for causing an apparatus to perform the method as described above. Additionally or alternatively the method may include selecting a plurality of candidate features of the data set, each of the candidate features comprising or being derived from one or more of the criteria. The method may include, for each candidate feature, determining an information content metric for values of data entries within the criteria of the candidate feature. The method may include selecting one or more of the candidate features to be the features within the data set to use for outlier detection analysis at least partially using the determined information content metrics.

Other embodiments of the above computer-readable medium, commensurate with the above-described method, may also be provided for.

According to other aspects, there is provided a method, apparatus and computer-readable medium in which outlier characteristic metrics are generated for each of a set of data items, and for each one of the set of data items, the outlier characteristic metrics are combined to generate an ensemble outlier metric. Details of such generation and combination may be as set forth above. Furthermore, weightings can be applied to each of the metrics during the combining. The weightings can be adjusted via machine learning and/or manual input. The machine learning may adjust the weightings in response to feedback indicative of effectiveness of the outlier characteristic metrics. The weightings can be set, and/or the combinations configured, using diversity metrics, effectiveness metrics, information content metrics, correlations, or the like, or a combination thereof, as described elsewhere herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates aspects of a data set, features, outlier detection operations, and associated metrics, in accordance with an illustrative embodiment of the present invention.

FIG. 2 illustrates aspects of generating and using an ensemble of outlier detection operations for processing a data set, in accordance with embodiments of the present invention.

FIG. 3 illustrates examples for determining an information content metric, according to an embodiment of the present invention.

FIG. 4 illustrates examples for selecting or filtering candidate features, according to an embodiment of the present invention.

FIG. 5 illustrates an example of correlations between candidate outlier detection algorithms or operations, according to an embodiment of the present invention.

FIG. 6 illustrates procedures for generation and calibration of an ensemble of outlier detection operations for data analysis, according to an embodiment of the present invention.

FIG. 7A illustrates procedures for generation and selection of features for use in an ensemble of outlier detection operations, according to an embodiment of the present invention.

FIG. 7B illustrates procedures for generation and selection of features for use in an ensemble of outlier detection operations, according to another embodiment of the present invention.

FIG. 8 illustrates selection of outlier detection algorithms for use in an ensemble of outlier detection operations, according to an embodiment of the present invention.

FIG. 9A illustrates calibration of outlier detection operations according to an embodiment of the present invention.

FIG. 9B illustrates operations for adjusting weights in an outlier detection ensemble, according to an embodiment.

FIG. 10 illustrates operations for selecting outlier detection operations based on effectiveness and/or diversity metrics, according to an embodiment of the present invention.

FIG. 11 illustrates a computing apparatus which may perform some or all of the operations of the present invention.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs.

Embodiments of the present invention pertain to identification (or detection) of outlier data entries within a data set. The term outlier is described elsewhere below. The data set typically includes multiple data entries, one or more of which can be potentially classified as outliers. The data set may be structured data including numerical data. As a primary example, the data set may be a ledger such as a business ledger pertaining to a financial system or business process. Examples of business ledgers include general ledgers, payroll ledgers, manufacturing ledgers, and inventory ledgers.

In more detail, each data entry will include a value for each of one or more (typically multiple) criteria. A criterion may be a field or portion of the data entry which is associated with a particular type of information. For example, a criterion may be an identifier for the data entry or for an entity corresponding to the data entry, or a particular aspect of a description for the data entry, such as a name, date, transaction value, location, subject, characteristic for the data entry, etc. The value for a criterion may be numeric, alphabetic characters or words, or other recordable information, or a combination thereof. For clarity, a criterion can be a characteristic of a data set as a whole, with different data entries in the data set at least potentially including respective values for that criterion. A feature may include one, two or more criteria, a relationship between criteria, or a function operating on criteria. A given feature may include or correspond to the values within data entries for one, two or more criteria. For a given data entry, one can consider the feature as applied to that data entry, by considering the values corresponding to the feature's criteria for that data entry, and possibly processing those values.

A feature may include part of a criterion or parts of criteria, or parts of fields corresponding to criteria. More generally, a feature can be, or can be derived from (e.g. be a function of), a substantially arbitrary part of a data entry or data set, i.e. one or more of the criteria. Typically a feature will be applicable individually to each data entry, i.e. so that given a data entry and a given feature, the data entry will have its own associated realization of that feature.

An example of feature derivation is as follows. A data set may include a field or criterion that indicates a date (and possibly time), and data entries may enter values for such a date/time. A feature that may be derived from this information may be, for example, the day of the week (e.g. Monday), the day of the month, the day of the year, the month, the year, the time of day, whether or not it is afternoon, whether or not it is morning, or whether or not it is night time.

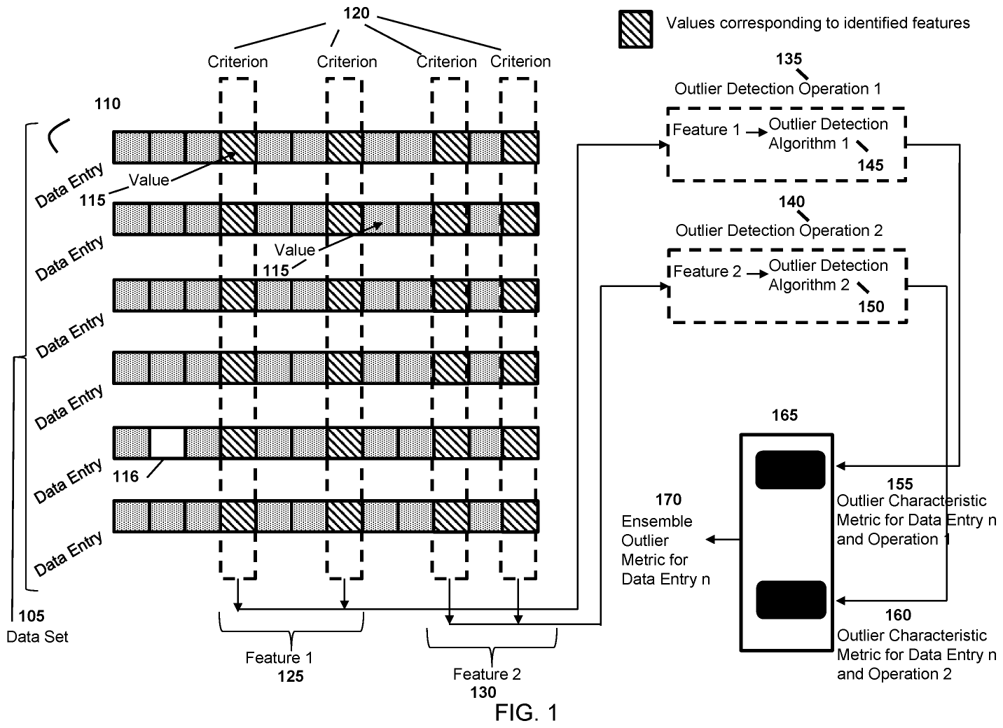

FIG. 1 provides an illustrative example showing a data set 105 including multiple data entries 110. The definitions here are for illustrative purposes and are not necessarily intended to be limiting. Each data entry includes multiple values (e.g. 115) for each of multiple criteria 120. Four criteria are shown specifically, although each column of values may be associated with its own respective criterion. As shown, each data entry includes values for all the same criteria, so criteria are shared across data entries. However, this is not strictly necessary—in other embodiments, a given data entry may be missing values for one or more criteria. In order to accommodate this, a value may be understood to include a “blank” or “missing” value. An example of a missing value 116 (e.g. in the form of a blank field) in a data entry is shown. FIG. 1 further illustrates two example features 125, 130. The first feature 125 is related to two of the illustrated criteria, and the second feature 130 is related to the other two of the illustrated criteria. A feature can include a set of criteria or a function or a relationship between criteria. As shown, a feature is a characteristic of the data set as a whole. For example the collection of values, across all data entries of the data set, which correspond to the criteria making up a feature, can compose or otherwise result in the feature. However it should also be noted that each data entry exhibits its own instance of such a feature. For example, the first data entry includes values which together compose or result in an instance of the first feature 125 for that data entry.

Incidentally, missing values of data entries can be handled in a variety of ways. The missing values can be predicted based on other (e.g. neighbouring values). In some cases, if an outlier detection operation cannot tolerate the missing values, it may be excluded from operating on that portion of the data, or excluded from the ensemble altogether. In some cases, outlier detection operations may be configured to tolerate missing values and predict them if necessary, a process that may be referred to as “imputing.” In some cases, outlier detection operations may be configured to treat missing values in a particular way, for example in order to detect outliers based at least in part on the presence of missing values. That is, a missing value may be a signal of an outlier.

FIG. 1 further illustrates two example outlier detection operations 135, 140 and generation of an ensemble outlier metric 170. These operations are described in more detail elsewhere herein. Briefly, an outlier detection operation operates on the values corresponding to a given feature. Thus the illustrated outlier detection operations 135, 140 each operate on two values taken from a given data entry n. More generally, an outlier detection operation can operate on one, two or more values and/or features at a time. These values are operated on by a particular outlier detection algorithm 145, 150, which is part of its respective outlier detection operation. The output of the outlier detection algorithm, applied to a given data entry n, is an outlier characteristic metric 155, 160 for that data entry and outlier detection operation. The outlier detection operation can operate on each data entry in this manner. The outlier characteristic metrics 155, 160, from all performed outlier detection operations on a given data entry, are then combined by a combiner 165 to produce an ensemble outlier metric for that data entry. This combining may be performed on a per-data-entry basis, i.e. by combining outlier characteristic metrics for a given entry to produce an ensemble outlier metric 170 for that data entry. The combining can be performed for example using a weighted sum or weighted average of outlier characteristic metrics, or using another appropriate function. Ensemble outlier metrics for different data entries are typically generated in the same manner, i.e. using the same combining rule. Thus, ensemble outlier metrics for each data entry can be generated. A metric may be viewed as a score indicating a measurement of how unusual or interesting a data entry is in terms of being a potential outlier.

Although outlier detection operations are described primarily as operating on data entries, they can also operate on combinations of data entries, such combinations being referred to as data items. Two or more data entries can be grouped together to create a data item, and the outlier detection operations applied to these defined data items. A data item can be, for example, multiple data entries which correspond to a same transaction.

An outlier data entry, or more succinctly an “outlier,” may be a data entry which is abnormal (also referred to as anomalous or exceptional) in one or more manners, which may be specified to at least some degree. An outlier may differ significantly from other data entries. The manner in which a data entry is an outlier is context-dependent. An outlier data entry, in the statistical sense, can be a data entry which, after quantification, exhibits a value that is significantly different from that of other data entries, for example as measured using an average for an assumed or observed statistical distribution for the data entries. This significant difference can be, for example, in terms of the data entry being a predetermined number of standard deviations away from the average. Other statistical definitions of an outlier can also be used. Analogously to statistical definitions, other definitions of an outlier can also be used, for example to describe that the data entry is measurably different from typical or expected data entries, in a way that is likely (or with some probability or confidence level) due to a significant cause, i.e. more than random chance or non-significant cause. As will clarified below, the term “outlier” is not necessarily limited by the above description.

An outlier may be a data point of interest to a user (e.g. investigator)—it may be an anomaly or irregularity in data. An outlier may be indicative of an operational or data entry error, or an attempt at fraud or data falsification, or the like. Because the data set includes structured data, and is generated according to a set of rules (e.g. financial controls), deviations from these rules can be detected as outliers. Data points may be evaluated on a scale from more anomalous to less anomalous, desirably with most or all different data points having distinct values in this regard. The data points that are (relatively) the most anomalous, or have an anomaly score above a predetermined threshold, can then be flagged as potential outliers.

It may be challenging to define or decide what constitutes an outlier in a given data set. The definition may vary depending on the data, the application, or what a user (e.g. investigator) considers significant at the time, for example. Embodiments of the present invention may therefore address this challenge by providing tools for processing data to identify (detect) outliers, even if it is not clear what might constitute an outlier, at least initially. This may be accomplished through computer-assisted interaction with data, e.g. in the manners described herein, using certain computing operations to help process or interact with a data set in such a manner that a useful definition of “outlier” can be determined, as well as identifying (detecting) data entries which qualify as outliers under such a definition. Identifying outliers may refer to flagging outliers which, once flagged, clearly qualify as outliers on their face. Detecting outliers may refer to flagging outliers which may not obviously be outliers until more closely inspected in context.

Because data sets can differ significantly, and the definition of an outlier can also differ significantly, a single standardized method for detecting outliers in all situations is unrealistic. Furthermore, manually creating such a method can be complex, time-consuming, and can require significant expertise. In addition, such manual creation is highly likely to result in the method including bias, imported from the biases of the creator. By automating the process of generating a customized outlier detection method for a given situation, such difficulties can be addressed. The relative lack of human-induced bias may also make the outlier detection method more difficult to circumvent. At the same time, human (user) expertise can still be used in the generation of the outlier detection method, for example by soliciting limited feedback from a user during the generation. The feedback may be in the form of yes or no (binary) questions, or questions with a limited number of predetermined responses (e.g. presenting a statement and asking the user to rate their agreement with the statement on a scale). Once an outlier detection method for a certain scenario is generated, it can be performed thereafter substantially without change, or it can be intermittently or continuously varied or improved upon.

Automated generation of an outlier detection method can, however, be computationally intensive. For example, a large data set can have a large number of potential features, each of which can be operated on by any one of a large number of potential outlier detection algorithms. Exhaustively evaluating each possible ensemble outlier metric resulting from this could require an unrealistic amount of computation. Therefore, various heuristics and principles may be employed, as described herein, to facilitate generation of an appropriate outlier detection method using an appropriate amount of computation.

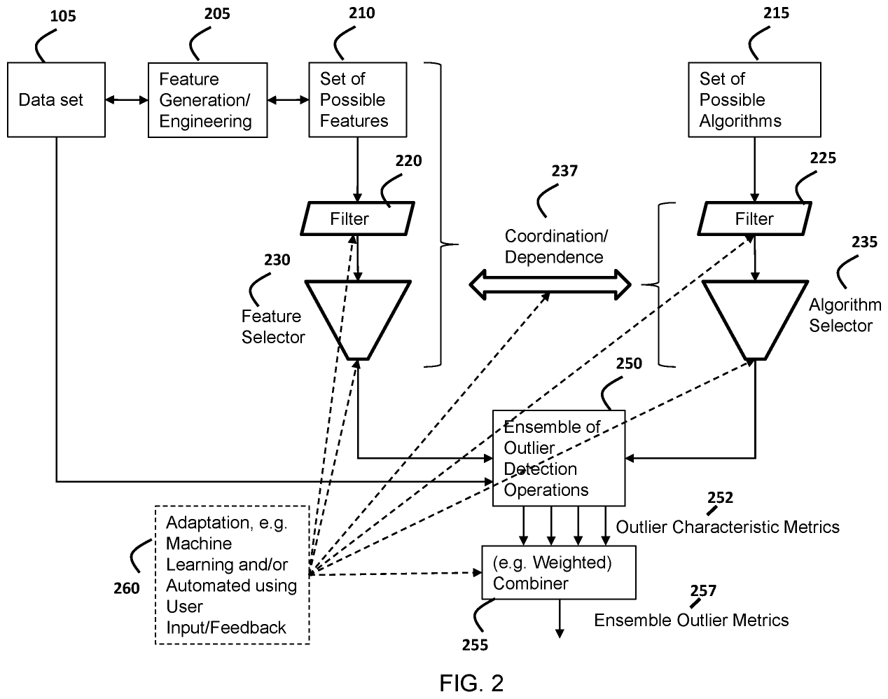

FIG. 2 illustrates certain embodiments of the present invention, in relation to outlier detection. The features of FIG. 2 are briefly described here to orient the reader, and these features are described in more detail elsewhere below. According to FIG. 2, a data set 105 is provided from which a set of possible features 210 is obtained, for example according to fields or values for data entries in the data set. Obtaining the set of possible features may involve feature generation (feature engineering) 205 as described below. The set 210 includes some or all possible features, each of which can involve one or more criteria. It is desired to automatically construct a processing routine which adequately identifies outliers in the data set. For this purpose, an ensemble 250 of outlier detection operations is selected and used to process the data set. Each outlier detection operation in the ensemble 250 involves an outlier detection algorithm operating on at least one feature. Thus, both the features and outlier detection algorithms need to be selected. For feature selection, the set of possible features 210 may be filtered 220 to remove some of the features based on certain rules as explained elsewhere herein. Feature filtering may be omitted in some embodiments. Then, a feature selector 230 selects features from the (e.g. filtered) set of features. Each of the selected features is then used in (at least) one of the outlier detection operations of the ensemble 250, along with one of the selected algorithms. A set of possible algorithms 215 may also be filtered 225 to remove some of the algorithms based on certain rules as explained elsewhere herein. Algorithm filtering may be omitted in some embodiments. Then, an algorithm selector 235 selects algorithms from the (e.g. filtered) set of algorithms. Feature filtering 220 and selection 230 may be performed in coordination 237 with algorithm filtering 225 and selection 235. For example, algorithm selection may depend on aspects of feature selection and/or vice-versa. As a further illustrative example, once a feature is selected, an appropriate algorithm for processing that feature may also be selected. Similarly, features or algorithms may be filtered out if there is no corresponding algorithm or feature which is usable therewith. Coordination 237 may be one-way or two-way. Feature filtering may involve assessing correlation, similarity and/or variability between features, and filter out (discard) features which are too highly correlated or which hold insufficient information. Principle component analysis may be performed on multiple highly correlated features, which may result in generating a new feature representing a combination of the highly correlated features. Filtering of multiple items may involve inhibiting use of all of the multiple items. For example, given two or more items (algorithms, features), the filtering may inhibit all of the set of items from being selected for subsequent use, thus tending to reduce the number of items in the set for further use.

Feature generation (feature engineering) 205 may proceed as follows. Based on the data set 105, and possibly based on some or all features 210 identified therein, one or more additional features can be generated 205. These additional features can be generated or derived from criteria in the data set, other identified features in the data set, or a combination thereof. The additional features can be functions of data set content, for example. As an example, feature generation can involve creating features (e.g. day of week) from date fields. Various functions or transformations can be applied to data to create features therefrom.

As another example, features can be generated which categorize data (e.g. values). For example, given numeric data in one or more criteria, two or more ranges into which instances of the numeric data (each corresponding to a data entry) might fall can be identified. Then, for each data entry, the range into which its corresponding numeric data falls can be identified. A generated feature can thus indicate, for a given data entry, which one of the ranges its numeric data falls into. Features can be further generated from such ranges. For example, based on a postal code or ZIP code, a feature indicating general geographic location can be generated.

In various embodiments, the coordination 237 may involve coordinating the feature generation 205, set of possible features 210, or both, with the algorithm selection 235. For example, whether or not a particular algorithm is a candidate for selection may depend on whether or not the features required for operation of that algorithm are present in the set of possible features, or can be generated by feature generation 205. Similarly, if a particular algorithm is selected, the set of possible features 210 may be analyzed to ensure the features required by that algorithm are present, and, if they are not, they can be generated via feature generation 205. Accordingly, feature generation can operate to accommodate the possible needs for candidate algorithms and/or selected algorithms.

In some embodiments, when two or more features are determined to be highly correlated or close in an information-theoretic sense, as described elsewhere herein, these features may be combined together or processed to generate a new feature. Thus, for example, feedback from the feature filter 220 may be used to direct feature generation 205.

Generated features may be composites based on multiple other features, or amalgamations of other features. Once such generation is performed, the other features may be omitted from the set of all possible features. Therefore, feature generation may result in a reduction of the number of possible features.

Once the ensemble of outlier detection operations is selected, the ensemble 250 operates on the data set 105 so that each outlier detection operation produces its own (e.g. per-data-entry) outlier characteristic metric(s) 252. Values from the data set corresponding to selected features are obtained and processed using corresponding selected algorithms. Then, a combiner 255, such as a weighted combiner combines the outlier characteristic metrics to produce (e.g. per-data-entry) ensemble outlier metrics 257. Each ensemble outlier metric may indicate the degree to which a corresponding data entry is potentially an outlier.

The above process can be subject to adaptation 260 for example by being iterative, or subject to machine learning, or use user feedback, or a combination thereof. Adaptation can be used to adjust the feature filtering 220, algorithm filtering 225, feature selector 230, algorithm selector 235, and/or coordination aspect 237 of such filtering and selection. Adaptation may be based on results, such as generated ensemble outlier metrics, which are evaluated by a user or machine learning algorithm or combination thereof. Adaptation can be used to make adjustments before results are obtained, for example by configuring filtering and/or selection operations based on initial information indicative of a desired outcome, such as particular characteristics of outliers of interest.

Embodiments of the present invention relate to building analytic AI ensembles automatically for detecting outliers. Ensembles allow multiple methods of analysis, where each method is potentially a weak predictor or detector of a given scenario to produce a strong or more robust prediction. Using multiple methods potentially increases the chances of one method working well or working on a new or unseen scenario. Each method contributes its output (e.g. score or decision, which may be incorporated into a corresponding outlier characteristic metric) to the ensemble which aggregates the participating scores to generate an overall score (e.g. ensemble outlier metric).

Ensembles implement design diversity, which may improve robustness, by employing more than one anomaly detection method. Each component in the ensemble can be designed to detect a specific scenario so that, when required to explain a decision, the system can indicate which ensemble components (outlier detection operations) and therefore which factors and causes triggered the decision. There is also a lack of a single source of bias advantage in ensemble systems as each method when created with a different approach or different training data can counteract any single source of bias.

According to embodiments of the present invention, one manner by which outlier detection can be supported uses feature selection. One, two or more features of a data set are selected to use within one or more outlier detection operations (as also determined as described elsewhere herein). Typically, multiple features are selected, in accordance with the principle of using an ensemble of outlier detection operations. However, in some embodiments, multiple outlier detection operations might use the same feature, so it is possible that only one feature is selected. Features can be selected based on certain predetermined rules. For example, features with relatively high variation or information content can be selected while features with relatively low variation or information content can be refrained from being selected. Features with data that is not appropriate for or usable by certain outlier detection operations can be refrained from being selected for use with such operations. If multiple features are significantly redundant with one another, selection of such features may be limited to a small number (e.g. one). Selection may be performed following generation of new features.

In some embodiments, one or more features can be selected based on information content as follows. First, multiple candidate features of a data set are selected/generated, for example arbitrarily, via user selection, or according to a predetermined rule. In some embodiments, all possible features are initially selected as candidate features. Recall that a feature can include a set of one, two or more criteria (e.g. fields containing values) in a data set, or a characteristic derived from such criteria, e.g. a relationship between criteria. Then, for each of the candidate features, a respective information content metric is determined. After the information content metrics are determined, certain ones of the candidate features can be further selected based at least in part on these determined information content metrics. The features are thus selected to be the features to be used in subsequent outlier detection operations. The basis of selection can be relative values of information content metrics, for example.

The information content metric may be for, or representative of, values of data entries within the criteria of the candidate features. The information content metric measures the data set as a whole, i.e. based on collective values taken from multiple data entries (specifically those values corresponding to the criteria making up the candidate feature). The information content metric can measure the amount of information contained in those data set values making up or corresponding to a feature. If the feature is obtained by combining or operating on criteria using a function, the information content metric can measure the amount of information contained in the outputs of such a function as applied to the data set values making up the feature.

A variety of information content metrics can be used. For example, the information content metric can be a measure of variability in the values corresponding to a feature. If such values are all the same, or have limited variability (e.g. the values are all a single consistent name field), the information content metric can be correspondingly low. If there are many different values, the information content metric may be higher. As another example, the information content metric can be a measure of unpredictability in the values corresponding to a feature, given other such values. For example, if the values increase incrementally from data entry to data entry, the predictability may be high and thus the information content metric may be low.

As another example, the information content metric can be an information-theoretic metric, such as an entropy metric, or a potential data compression rate metric. As an illustrative example which is not necessarily intended to be limiting, for a candidate feature, a probability distribution can be generated according to a frequentist paradigm. For example, the values for that feature can be assigned to bins with each bin representing a possible value or range of possible values. The size of each bin, relative to (e.g. divided by) the sum of all bin sizes, can then be interpreted as the underlying probability distribution of a random variable. Scalar-valued random variables, vector-valued random variables, or collections of random variables can be defined in this manner. As will be readily understood by a worker skilled in the art of information theory, the (Shannon) entropy of such a random variable X, in mathematical terms, is the expected value of the negative logarithm of the probability distribution of the random variable, i.e. E[−log p(X)]. Other comparable definitions of entropy (e.g. measures of information content) can also be used. The entropy reflects the average level of information inherent to the random variable's possible outcomes. The entropy reflects the average level of information inherent to the random variable's possible outcomes. A higher entropy value generally indicates a higher value of information content metric. The Shannon Entropy calculations may be used for example to calculate the amount of information there is in an event, using the probability of the event. Accordingly, Shannon entropy calculations, such as above, can be performed on the values of data entries of a candidate feature to determine an information content metric. Other Shannon entropy calculations can also be used, such as joint entropy calculations, conditional entropy calculations, mutual information calculations, or the like, or a combination thereof, as will be readily understood by a worker skilled in the art. As used herein, the term “entropy” may refer to Shannon Entropy or similar metrics.

Often related to entropy is the concept of potential data compression rate. For example, the average length of a variable-length (lossless) binary code usable to communicate values taken on by random variable X, knowing its underlying probability distribution, in the best case, approaches the entropy of X. More generally, one can consider the values of the data entries for a candidate feature, and compute potentially (e.g. using the associated probability distribution defined above) or test empirically how much this data can be compressed. The information content metric may be measured as the rate of compression that can be achieved on a given feature or criterion. In some embodiments, information content metrics can be generated based on the result of an algorithm as well as the input features. Such an embodiment may be implemented based on the principle that algorithm results which contain low information content would also be less valuable to an analysis. Other information content metrics which are increasing functions of such an average length of the code can similarly be derived. Similarly, a potential compression rate can be defined as the ratio between an uncompressed data size and a compressed data size. In this case, the uncompressed data size is the amount of bits (or other units) required to represent the values of the data entries for the candidate feature, while the compressed data size is the amount of bits required to represent the same values after a data compression operation (source coding operation) is performed. The data compression operation can be a predetermined operation or a theoretically optimal but potentially unspecified operation. In this case, the information content metric is a decreasing function of (e.g. inversely proportional to) the potential compression rate. For example, when data can be compressed by a large amount, it suggests that there is relatively little information contained therein. Conversely, when data can only be compressed by a small amount, it suggests that there is a relatively large amount of information contained therein.

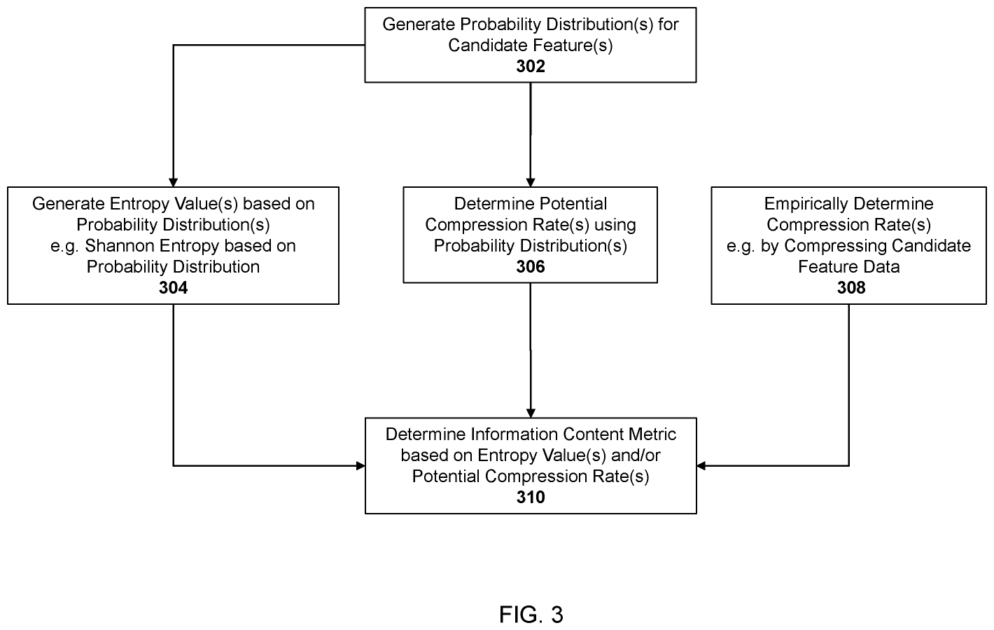

FIG. 3 illustrates the above examples for determining an information content metric in more detail. One, two or all three branches of operations can be performed. The operations include generating 302 probability distributions for candidate features, for use as a basis of further computation (e.g. by considering a random variable having the underlying generated probability distribution). The operations include generating 304 entropy values based on the probability distribution(s), such as a Shannon Entropy value as discussed above. The operations include determining 306 potential compression rates using the probability distribution(s). The operations include empirically determining 308 compression rates for example by actually compressing candidate feature data. The operations include determining 310 an information content metric based on the generated entropy values or determined (potential or empirical) compression rates.

The above examples of information content metric may be applicable to a given feature in isolation. However, in other cases, an information content metric may be applied to compare two or more features to determine relative information content of the features. Relative information content may refer to a comparison of information content (as measured using some metric) between different features. Moreover, such comparative information content metrics can be used to filter out certain candidate features, so as to inhibit the use of too many highly correlated or highly redundant candidate features in the same overall ensemble of outlier detection operations.

Determining relative information content of multiple features can involve determining a statistical correlation between the features, which may be candidate features. For example, each feature can be treated as a random variable with an underlying probability distribution constructed from its constituent values as already described above. An underlying (e.g. joint) probability distribution for multiple features considered together can similarly be defined. A correlation coefficient between (e.g. two) features (or candidate features) can then be generated for example based on measures of covariance and standard deviations, as will be readily understood by a worker skilled in the art.

For purposes of filtering, correlations (e.g. correlation coefficients) between multiple pairs of candidate features can be determined. Then, pairs of candidate features can be identified which are highly correlated, for example by exhibiting a correlation coefficient which is above a predetermined threshold, or by exhibiting a correlation coefficient which is among the highest (e.g. the highest 0.1%, 1%, 5% or some other percentage) of the measured correlation coefficients. For one or more of the highly correlated pairs of candidate features, a selection rule can be applied which inhibits both of such a pair of candidate features from being selected for use. This filters out one of the highly correlated candidate features from being selected. As an example, one of the highly correlated candidate features can be discarded from further consideration, selected for example arbitrarily or in response to user input. As mentioned elsewhere, in some embodiments, highly correlated features are combined together to generate a new feature.

Determining relative information content metrics for multiple features can involve determining an information content metric for the multiple features collectively. For example, consider random variables X and Y representing two features. The underlying probability distributions p(X) and p(Y) for such random variables can be defined as described above. Furthermore, a joint probability distribution p(X,Y) can be similarly defined, based on the values of the two features considered together. Measures such as joint entropy, conditional entropy, and mutual information can be determined using these probability distributions, as will be readily understood by a worker skilled in the art. Filtering of features as described above can be performed using mutual information or a related information content metric, for example, rather than or in addition to using correlation coefficients. Such relative or joint information content metrics can also be used to filter or select features for further use.

Similarly, features can be selected based on an information content metric which is a decreasing function of (e.g. inversely proportional to) a potential compression rate for values of features, considered together. (Alternatively, the information content metric can be an increasing function of an average code length for source encoding values for multiple features taken together.) For example, one can determine a compression rate for data of two, three or more features when encoded together. As above, the compression rate can be a theoretical best rate or an empirically determined best rate. Such a compression rate can be indicative of a corresponding level of correlation or mutual information between the features. Filtering or feature selection can then be performed using such a derived metric.

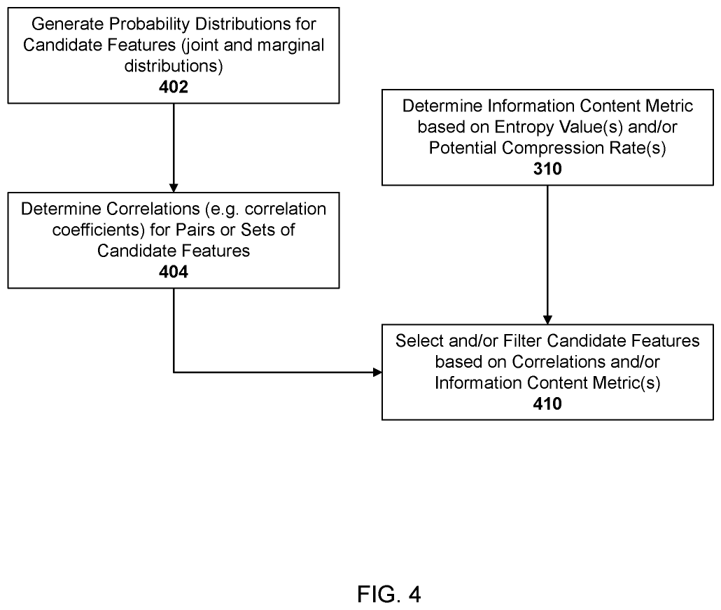

FIG. 4 illustrates the above examples for selecting or filtering candidate features in more detail. One or both branches of operations can be performed. The operations include generating 402 probability distributions for candidate features, similarly to operation 302 above. Both joint and marginal probability distributions may be generated, as required. The operations include determining 404 correlations for pairs or sets of two or more candidate features based on the probability distribution(s). The operations include the above-described determining 310 information content metric(s) based on the generated entropy values or determined (potential or empirical) compression rates. The operations include, based on the above determinations, the operation 410 of selecting candidate features, filtering out certain candidate features from further selection, or a combination thereof.

According to embodiments of the present invention, another manner by which outlier detection can be supported uses outlier detection operation selection. More particularly, a plurality of existing outlier detection operations are selected to form an ensemble of detectors. As explained above, an outlier detection operation involves an outlier detection algorithm and a corresponding feature upon which the algorithm operates. That is, an outlier detection algorithm is run using, as input, values of the data set for criteria belonging to one of the selected features. In some embodiments, a feature can be selected (e.g. as described above), and then an appropriate outlier detection algorithm can be selected to operate on that feature, thus resulting in selection of an outlier detection operation. In some embodiments, an outlier detection algorithm can be selected, e.g. based on operating requirements, and an appropriate feature upon which that algorithm is to operate is then selected, thus resulting in selection of an outlier detection operation. In some embodiments, features and outlier detection algorithms can be selected interdependently to result in selection of an outlier detection operation.

A variety of outlier detection algorithms may be available for selection. Each of the outlier detection algorithms may operate on particular types of data to produce a particular type of result. Different classes of algorithms may also be available, such as rules-based algorithms which process data according to a designed and fixed set of rules such as statistical rules or rules implementing domain expertise, and machine-learning-based algorithms which process data according to a machine learning model which has been trained for a given purpose.

Examples of outlier detection algorithms include Missing Values, Date-Time Consistency, Isolation Forest, Local Outlier Factor (LOF), Robust Principle Component Analysis (RPCA), K-Means, Cyclic Regression, K-Means with date-time, Z-Score, Groupby Z-Scores, Account Flurry, Rare Interactions, Groupby K-Means, Trend Shock, and Markov Chain algorithms. The Missing Values algorithm identifies missing entries in the data set, e.g. missing data entries or missing portions of data entries. The Data-Time Consistency algorithm identifies order relations between pairs of date-time columns and flags unusual rows which deviate from such order relations. The Isolation Forest algorithm is a robust tree-based anomaly detection algorithm. The Local Outlier Factor (LOF) algorithm performs high-dimensional detecting using local density around points. The RPCA algorithm decomposes data into sparse and dense components, identifies anomalies as sparse noise and is a variant of PCA. The K-Means algorithm performs high-dimensional clustering using Euclidean distance. The Cyclic Regression algorithm cycles columns and builds a stepwise regression model and at each step picks features most correlated with a chosen response. The K-Means with date-time algorithm is similar to the K-means algorithm but includes date-time columns. The Z-Score algorithm produces a score based on distance to the mean measured in standard deviations. The Groupby Z-Scores algorithm is similar to the Z-Score algorithm after filtering by values in a categorical column. The Account Flurry algorithm identifies sharp unusual counts of entries in time-series data. The Rare Interactions algorithm measures low frequency of data occurrences in pairs of categorical column. The Groupby K-Means algorithm is similar to the K-means algorithm with clustering after grouping values in a given categorical column. The Trend Shock algorithm identifies sharp unusual changes in numerical values in time-series data. The Markov Chain algorithm is an unusual sequence based anomaly detection algorithm.

In more detail, and in some embodiments, the Missing Values algorithm identifies data integrity issues by flagging missing values. The Data-Time Consistency algorithm identifies date-time columns entered in reverse order. The Isolation Forest algorithm identifies unusual rows among numerical columns. The Local Outlier Factor (LOF) algorithm identifies unusual row among numerical columns. The RPCA algorithm identifies unusual row among numerical columns. The K-Means algorithm assigns points to clusters and identifies unusual rows based on the distance to the assigned cluster. The Cyclic Regression algorithm identifies anomalies based on fitted data in the model. The K-Means with date-time algorithm identifies outliers within numerical columns across date-time column. The Z-Score algorithm identifies outliers within numerical columns across date-time column. The Groupby Z-Scores algorithm identifies unusual numerical values belonging to a particular group in a given categorical column. The Account Flurry algorithm identifies unusual changes in counts of entries across time. The Rare Interactions algorithm identifies rare occurrences among categorical columns. The Groupby K-Means algorithm identifies outlier rows within clusters after averaging out across values in a categorical column. The Trend Shock algorithm identifies trend changes in time-series data. The Markov Chain algorithm identifies rare values in time-series data.

Further, the Missing Values and Data-Time Consistency algorithms are rules-based. The Isolation Forest algorithm is a ML (machine learning) Tree-based algorithm. The Local Outlier Factor (LOF) algorithm is a ML density-based algorithm. The RPCA is a ML matrix decomposition based algorithm. The K-Means, K-Means with date-time and Groupby K-Means algorithms are ML distance-based clustering algorithms. The Cyclic Regression algorithm is a ML regression algorithm. The Z-Score and Groupby Z-Scores algorithms are ML statistical algorithms. The Account Flurry algorithm is a ML time series algorithm. The Rare Interactions algorithm is a ML frequency-based algorithm. The Trend Shock algorithm is ML time series algorithm. The Markov Chain is a ML probabilistic/time series algorithm.

Selecting an outlier detection operation can include determining at least one outlier detection algorithm, from a set of candidates, that can accept as input (and thus use) one or more features of interest, such as features which have already been (or are concurrently being) selected for use. Candidate algorithms which are not compatible with certain features can be filtered out from selection for use in an outlier detection operation using such features. For example, certain features may include (e.g. non-numerical) value entries which are not appropriate for processing by certain (e.g. rules-based) algorithms which require numerical input.

As an example, a candidate algorithm may compare numerical field values to a threshold in detecting potential outliers, and thus requires numerical features. Similarly, this or another candidate algorithm may determine distances between data points (features), and thus requires numerical features. If relevant numerical features are not present in a data set, such a candidate algorithm may be deemed inappropriate and filtered out from selection. A similar process can be performed to filter out candidate algorithms which process particular types of data such as dates, or text, when no such dates or text is available in data set features.

A candidate algorithm which operates on a certain type of data may be determined to be incompatible with a certain feature when that feature does not contain such certain type of data. Such a candidate algorithm can be determined to not be able to use such a feature. Conversely, a candidate algorithm which operates on a certain type of data can be determined to be able to use a feature when that feature contains such certain type of data, or a precursor data which from which the certain type of data can be derived. For example, a feature may include numerical data indicative of time. A candidate algorithm can be determined to be able to use such a feature if it is able to operate on such numerical data indicative of time, as opposed to, for example, text data.

In various embodiments, the required parameters (e.g. data set features) for a particular algorithm to operate will be known. Embodiments can then search the data set to determine if there are any features in the data set that provide for such required parameters. If there are not, then the algorithm can be filtered out. Otherwise, the algorithm can be a candidate for selection. The search can be a prioritized search, in which certain combinations of data set fields (criteria) are prioritized in the search based on type, semantics, information content, etc. Tests can be performed on the data set to determine whether such fields are indeed appropriate and/or productive input for the algorithm.

Selecting an outlier detection operation can include testing candidate outlier detection algorithms using one or more features of interest. Based on the outcome of such testing, candidate outlier detection operations can be used in an outlier detection operation or else excluded from such use. The outcome may be a pass/fail outcome, or a score which is compared to a threshold or other scores for other tests, for example. For a given algorithm, the testing can involve running the candidate outlier detection algorithm using the features of interest (or a sample portion thereof) as input. The results of this operation, which are termed candidate algorithm results, can be evaluated using an effectiveness metric. The effectiveness metric can measure the ability of the candidate algorithm results to separate data entries for the purpose of outlier detection, using the feature(s) provided to it. Such testing can be performed for multiple features of interest, as well as for multiple candidate outlier detection algorithms. In some embodiments, the effective metric may be applied at an ensemble level, for example to measure the ability of the ensemble results to separate data entries for the purpose of outlier detection.

The effectiveness metric can be based at least in part on the degree to which the candidate algorithm assigns different outlier scores to different data entries. The outlier scores may indicate the degree to which a data entry is considered, by the candidate algorithm, to be an outlier. The degree to which different outlier scores are assigned to different data entries may correspond, for example, to the number (preferably zero) of data entries which receive the same score. The degree to which different outlier scores are assigned to different data entries may correspond, for example, to the degree to which the outlier scores reflect the likelihood that a data entry is an outlier. The degree to which different outlier scores are assigned to different data entries may correspond, for example, to the degree to which the outlier scores collectively exhibit a desired pattern, e.g. a logistical curve.

It is also noted that ensembles may be hierarchical in nature. That is, two or more outlier detection algorithms or operations can be associated together to create what may be regarded as a sub-ensemble, or else regarded as a new composite outlier detection algorithm or operation. This sub-ensemble or composite structure may have a particularly high effectiveness, for example, or be particularly suitable for certain purposes. Ensembles can be created at least partially using such composite outlier detection algorithms or operations.

Based at least partially on the outcome of the testing, certain candidate outlier detection algorithms, in combination with certain specific features they have been tested with, can be selected as the outlier detection operations for further use. For example, each candidate outlier detection algorithm in combination with a given feature or features yields an effectiveness metric score. The algorithm plus feature combinations yielding the highest relative effectiveness metric scores, or scores above a threshold, or a combination thereof, may be selected as constituting the outlier detection operations for use.

In more detail, the effectiveness metric may indicate how well a candidate algorithm can identify outliers of interest, either on its own or in combination with other candidate or selected algorithms. For example, if a candidate algorithm identifies a relatively small number of potential outliers with a relatively high accuracy (e.g. the outliers are in fact deemed outliers by a user or machine learning algorithm), then the effectiveness metric may be relatively high. The effectiveness metric may be a function of the selectivity (relatively small number of potential outliers) and accuracy, as applied to a given data set and/or particular features thereof.

The above procedures focus on determining outlier detection operations with high effectiveness. However, in addition (or alternatively) to effectiveness, embodiments provide for selecting an ensemble of multiple different outlier detection operations having high diversity. For this purpose, a diversity metric may be used in addition to or alternatively to an effectiveness metric. For example, the diversity metric may be applied in combination with the effectiveness metric, for example after applying the effectiveness metric. The diversity metric may be based on (e.g. statistical) correlation, or another measurement such as an information theoretic measurement or data compression ratio measurement. The diversity metric may be applied to candidate outlier detection algorithms, tested using values from one or more features as already described above. For multiple (e.g. some or all) candidate outlier detection algorithms each in combination with one or more features, candidate algorithm results can be obtained. Then, a correlation between different candidate algorithm results can be determined. For example, two such candidate outlier detection algorithms may be scored as being correlated to the degree that they produce similar conclusions, or identify data entries as being outliers to a similar degree. Highly correlated outputs often indicate less than a desired level of diversity or robustness, for example since the outputs may be detecting the same condition in the data set. Correlations between outlier detection operations can be determined and used similarly. When two candidates are highly correlated, selecting both candidates may be inhibited.

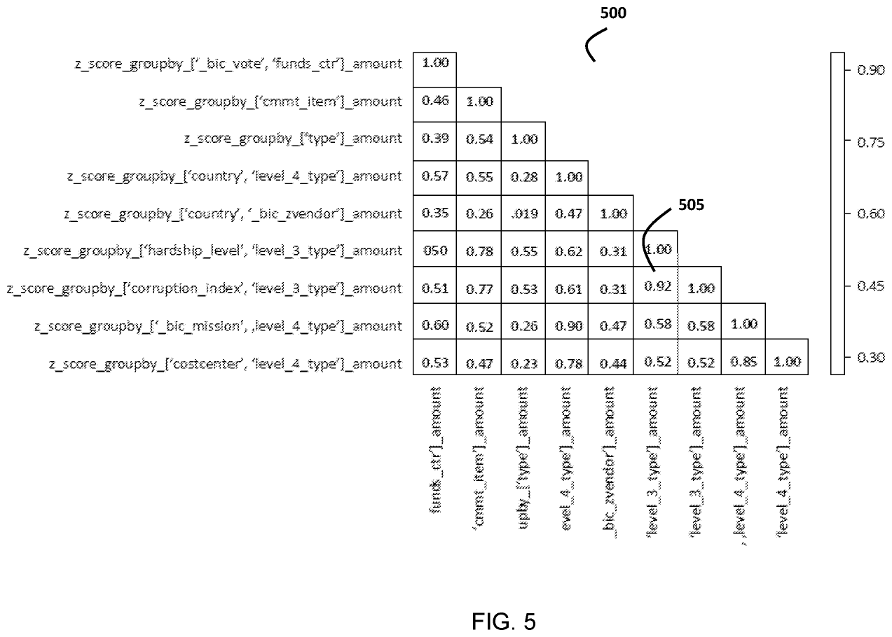

FIG. 5 illustrates an example of correlations between multiple candidate outlier detection algorithms (or alternatively, operations). Each row and column indicates the name of such a candidate outlier detection algorithm/operation, with the column names and row names being the same and in the same order. A correlation matrix 500 is illustrated which indicates correlations between pairs of algorithms' detections. Each row and column of the matrix corresponds to a particular algorithm, and the value (e.g. 505) corresponding to a given row and column indicates the correlations between the algorithms of that row and column. If two algorithms have a high correlation value (close to 1), they tend to detect the same scenarios, and thus are considered to have poor diversity. In such cases, one of the two algorithms may be assigned a lower weighting or excluded from the ensemble, e.g. via filtering or via selection rules. This can occur automatically or the situation can be automatically brought to the user's attention via prompts.

Based at least in part on the diversity metrics for multiple candidate outlier detection algorithms in combination with their associated features, certain outlier detection operations can be selected. The selection of a candidate outlier detection algorithm with specific associated features as an outlier detection operation can be based on its diversity metrics relative to diversity metrics for other candidate outlier detection algorithms and/or associated features. For example, the candidate outlier detection algorithms plus features which are more diverse can be selected as outlier detection operations. Put another way, a group of candidate outlier detection algorithms plus features which exhibit relative diversity can be selected as a set of outlier detection operations.

Although full automation of the ensemble generation process would be convenient, it is recognized that user input is typically required in order to create an ensemble which is appropriate for a given outlier detection task. A user (e.g. user, investigator) will typically have certain requirements for outlier detection, and thus user input is accommodated. The user interaction operations described below can be performed with the automatic filtering and selection operations described elsewhere herein to facilitate ensemble generation and adaptation.

In some embodiments, a user is allowed to select from a library of available algorithms to assist in creating the ensemble. Further, the user may be allowed to select which data set features a selected algorithm is to operate on, thereby selecting an outlier detection operation. Embodiments can then automatically select other outlier detection operations which complement the user selected operation(s).

In some embodiments, recommendations of outlier detection algorithms or operations are presented to a user, who can then accept or decline the recommendations. Recommendations of ensembles of outlier detection algorithms or ensembles of outlier detection operations can similarly be provided. The recommendations may be generated using the automatic filtering and selection operations as described elsewhere herein. The recommendations can be adjusted in response to user selection actions, for example by partially or fully re-performing the automatic filtering and selection operations.

In some embodiments, the outlier detection operations can be performed on a data set (or sample portion thereof) for a provisionally selected outlier detection operation and/or ensemble, so that the user can preview the results. The user can be presented with performance and/or effectiveness data for the ensemble, the constituent outlier detection operations, or a combination thereof. The user can then choose to manually alter the provisionally selected operation and/or ensemble, or trigger automatic alteration thereof, or solicit recommendations for alteration thereof, in view of the results. Parameters of outlier selection operations can be tuned manually or semi-automatically for example based on sample output of such operations, and/or based on automatically generated quality scores which can be based on such sample output. Effectiveness can be determined and tuned based on user-provided criteria, thresholds, weightings, or the like. For example, the user can specify the ratio of detections expected from an outlier detection operation. The ratio of detections may specify how many potential outliers are detected per quantity (e.g. 1000) of data entries. For example, the normal error rate for human data entry may be about 1 in 100, while the normal fraud rate in a data set may be about 1 in 2000, and these may be set as expected ratios for detecting such outliers. Such information can be useful for calibrating the effectiveness of anomaly/outlier detection. That is, to determine whether outlier detection is operating as expected, one may check whether it returns approximately 1/2000^{th} of data entries. Outlier detection operations can then be adjusted or selected based on the specified expectations. For example, one can normalize or scale an outlier score to provide that certain entries are assigned a sufficiently high risk score. The scores can be scaled so that potential outliers are detected at a frequency aligned with the expected detection ratio.

In some embodiments, user feedback specifying the ratio of detections (e.g. expected ratios of detected outliers) may be related to dynamic thresholds. For example, the user feedback can be used as a tuning parameter for the dynamic thresholds, or a tuning parameter for the dynamic thresholds may be generated or adjusted based on user feedback.

It is noted that, here and elsewhere, when outlier detection operations or ensembles are being evaluated by having them operate on a data set, the operations are not necessarily performed on the entire data set. Rather, the operations may be performed on a (e.g. randomly selected) sample portion of the data set. This may conserve computational effort while the operations or ensemble are being tuned.

In some embodiments, effectiveness of an algorithm, operation, ensemble, or portion of an ensemble can be determined and tuned based on user-provided criteria. The user can review and mark potential outliers as true outliers or falsely detected outliers, and such marking can be used to adjust the ensemble. For example, an outlier detection operation which returns more than a threshold amount of false positives, or more than a threshold ratio of false positives to true positives, can be assigned a lower weighting than was assigned previously, or even removed from the ensemble. The ensemble can thus be adjusted based on user feedback.

In some embodiments, in soliciting user feedback, the user may be provided with context, such as representative examples which can be compared to potential outliers that are presented to the user. The user may be provided with additional contextual information which may be used as a basis for comparison, so that they can more confidently decide whether the potential outlier is a true outlier or not. For example, a set of data entries that are similar to the potential outlier can also be identified (e.g. using a k nearest neighbours identification algorithm) and presented to the user. In some embodiments, a list of high scoring outlier items may be presented to a user, with reasons. The user would then indicate agreement or disagreement with items in the list. This may be a simple binary indication or an indication of the degree of agreement/disagreement. Additional context may be provided such as the source of the outlier scores, e.g. which algorithm has the strongest signal for the given outlier. In this way, more effective algorithms can be identified and weighted more heavily in the ensemble and less effective algorithms can be identified and weighted less heavily or removed from the ensemble.

In some embodiments, multiple ensembles can be automatically generated and presented to a user. The user may test each ensemble and select one of them for use. The user may provide feedback which can be used to adjust one of the ensembles. For example, the user may identify strengths and/or weaknesses of multiple ensembles, and a new ensemble can be generated by merging two or more of the ensembles so that the strengths are maintained and/or the weaknesses reduced.

In some embodiments, pre-configured ensembles (or sub-ensembles, or composite outlier detection algorithms) can be created based on one data set, and then made available for use in processing subsequent data sets. Such ensembles can be annotated with semantic information to assist in detecting similar data semantics in the new data set. This facilitates ensemble auto-configuration. Accordingly, ensembles, sub-ensembles or composite outlier detection algorithms can be re-usable entities. They may have tags or annotations to allow them to be more easily identified as re-usable in a given context. An example tag may be “Works with Inventory ledger” and each component algorithm can be tagged with its required fields like “Needs date field called Restock Date”. When all the right fields are present and even if they are not an exact match, the ensemble, sub-ensemble or composite algorithm could be automatically configured to operate on a new dataset. Such an entity can include algorithms that be implemented (or not implemented) automatically based on the presence (or absence) of the required fields.

Ensemble generation and customization can begin by implementing a previously configured ensemble, for example as generated for a previous data set or manually. This first iteration of the ensemble can then be evaluated and adjusted as necessary. Multiple pre-configured template ensembles can be made available, and one of these templates can be selected as the initial ensemble in an iterative process. The selection can be based on semantic tags, or the degree to which features required by each ensemble appears in the data set, or the like. The templates can be scored and one or more templates selected automatically based on scoring. The templates can be selected based on user input.

In various embodiments, the ensemble system itself can operate to detect which fields will work well with a chosen library or algorithms or an individually chosen algorithm. Pre-configured ensembles can be annotated with semantic information to help a detector to detect similar data semantics in the new target data set. This allows a library of algorithms to be automatically configure for operation in a new scenario. Algorithms may be tagged with information for example identifying their purpose, required fields, etc. Tags can be automatically processed for algorithm selection. For example, when a field or feature in a data set closely semantically matches a required field specified in an algorithm tag, that algorithm can be identified as a candidate for selection. Ensembles, sub-ensembles and composite algorithms can be similarly tagged and processed.

In some embodiments, when re-using pre-configured ensembles, some algorithms may be discarded from the ensemble automatically when requirements for such algorithms are not met by the content of the data set. The remainder of the ensemble may be automatically recalibrated after such discards.

In some embodiments, the ensemble is used to process a data set, to detect potential outliers and/or data issues. The user is subsequently presented with a series of findings and input from the user is solicited, e.g. as to whether or not they agree with each finding. In response to the input, the ensemble can be adjusted, or adjustments can be proposed. Multiple users can provide input in this manner, and conflicting input can be resolved for example by soliciting further input. The ensemble can be adjusted by adjusting weights applied to outlier detection operations, by adjusting the outlier detection operations themselves, or a combination thereof. The process can be repeated iteratively until a satisfactory ensemble is generated.

In some embodiments, before and/or after a satisfactory ensemble is generated, the ensemble can be adjusted over time based on user feedback. For example, a user can confirm that a potential outlier is indeed an outlier, or identify that a potential outlier is not an outlier for their purposes, and the ensemble can be adjusted based on such feedback.

As previously mentioned, multiple outlier detection operations are typically selected in order to create an ensemble of such operations. An ensemble is considered to be useful since each operation of the ensemble can focus on a certain aspect of outlier detection, and the benefits of different operations can be realized without requiring any single operation to perform well in all respects. The number of operations in the ensemble can be adjusted for example to provide for a certain quality of result with less than a certain maximum amount of required computation. Once the ensemble is created using the selection processes as described above, the outlier detection operations of the ensemble can each be performed to generate respective outlier characteristic metrics.

The outlier characteristic metrics are used for evaluating the data entries, and thus each performed outlier detection operation generates an outlier characteristic metric for each data entry, where applicable, by applying the operation to the data entry. A given outlier detection operation can generate one or more corresponding outlier characteristic metrics, each being representative of a different corresponding data entry of the data set. Thus, the outlier characteristic metric can represent the extent to which that data entry is (or is not) an outlier. An outlier characteristic metric is based on the outlier detection algorithm being used in the outlier detection operation, as well as the features provided to the algorithm. For example, an outlier characteristic metric may be a quantitative measure of likelihood that a corresponding data entry is out of order, or has been manipulated as part of a fraud attempt, or contains an error, exceptional or unexpected value, or the like.

The ensemble of outlier detection operations may thus provide, for some or all data entries, a vector of plural outlier characteristic metrics (e.g. numerical values). Although this vector can be used directly to evaluate which data entries are potential outliers, in various embodiments some or all of the outlier characteristic metrics can be combined, for each applicable one of the data entries, to generate an ensemble outlier metric for that data entry. Generally, the ensemble outlier metric is indicative of a degree to which the corresponding data entry is potentially an outlier, according to the definition of “outlier” currently in use for data investigation. A useful ensemble outlier metric may score assign only a small proportion of data entries a high score. Furthermore, a useful ensemble outlier metric may assign most or all data entries different scores. Embodiments may be configured to produce such useful ensemble metrics, by various actions such as weightings, feature selection, algorithm selection, etc.

The ensemble outlier metric may be, for example, a weighted or unweighted combination (e.g. sum or average) of the outlier characteristic metrics, or a value of a maximum or minimum one of the outlier characteristic metrics, or some other scalar-valued function of the outlier characteristic metrics, or the like. The ensemble outlier metric is generated in such a way as to be representative of which data entries are potential outliers, using a lower-dimensional measurement than the vector of all outlier characteristic metrics. The weight applied, e.g. as a multiplier, to each outlier characteristic metric may be an increasing function of the amount of interest or usefulness accorded to the outlier detection operation generating that metric. For example, outlier detection operations which are of relatively higher relevance in detecting an anomaly may be assigned a relatively higher weight, compared to other outlier detection operations.

In some embodiments, the weighted combination of outlier characteristic metrics may be performed using weightings which are adjusted according to manual input. The manual input may be direct, or may be the result of a series of queries provided to a user. For example, the queries may ask the user to indicate whether or not (or to what extent) they agree with a given statement or finding. As another example, the weightings may be manipulated directly. The weightings may reflect the user's preferences in this regard, to preferentially identify outliers which are deemed to be of more interest to the user.

In various embodiments, and in the above manner (for example), the weighting can be adjusted according to a semi-supervised machine learning operation. The machine learning operation can adjust weightings according to a machine learning model, based on training data which includes user feedback. The feedback can indicate user agreement or disagreement with output, user confirmation that a detected outlier is in fact an outlier (true positive), user indication that a detected outlier is not an outlier (false positive), or the like, or a combination thereof. For example, a sample detected outlier and/or a sample non-outlier can be presented to a user. If the user agrees that the sample is an outlier (or not, as the case may be), the weighting for the algorithm(s) that detected that outlier (or indicated it was not an outlier) may be increased. In the case of disagreement, the weighting may be decreased. Algorithms can similarly be excluded from the ensemble in response to such disagreement from the user.

In various embodiments, the weightings can be initially set to a first set of values, e.g. equal weightings or suggested weightings. A user can then adjust the weights based on their expertise or based on test runs of the ensemble. The weight of a particular outlier characteristic metric in the ensemble can for example be increased when it is known or expected to more strongly or reliably detect outliers of interest.

In some embodiments, the weighted combination of outlier characteristic metrics may be performed using weightings which are adjusted using machine learning. The machine learning model may adjust the weightings in response to feedback indicative of effectiveness of the outlier characteristic metrics in identifying significant outliers. The feedback may be user feedback. Feedback may be obtained by presenting results to the user who can validate or note that an outcome is what is expected, via an interactive process of having a person review outcomes. Accordingly, in response to feedback indicative of an outlier detection algorithm or operation's low effectiveness in identifying outliers, a machine learning operation may adjust the weight assigned to that algorithm or operation in an ensemble.

Additionally or alternatively to adjusting the weightings based on effectiveness of outlier characteristic metrics, outlier detection operations can be selected or avoided based on the above-mentioned feedback indicative of effectiveness of outlier characteristic metrics. Accordingly, in response to feedback indicative of an outlier detection algorithm or operation's low effectiveness in identifying outliers, a machine learning operation may avoid selecting that algorithm or operation for inclusion in an ensemble. For example, one algorithm may have no beneficial effect in an outlier detection process, and if this algorithm never has signals considered valuable after feedback then the algorithm may be entirely excluded. Alternatively, an algorithm may strongly signal valuable anomalies but only in 30% of the cases; in this case the algorithm will require other algorithms to with in order to be fully effective.

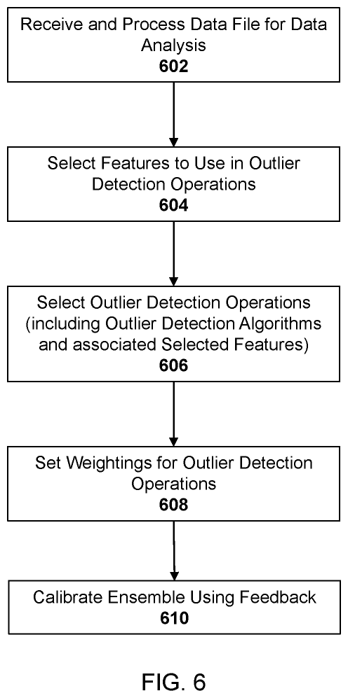

Some example flow charts and embodiments are described in more detail below. FIG. 6 is a flowchart depicting steps of a method performed using a processing entity of a computing apparatus to generate and calibrate an ensemble for data analysis according to an embodiment of the present invention.

At step 602, the processing entity may be used to receive and process a data file for data analysis. The data files may be received from a wide range of sources including via a network, input device, or local data storage. In one sample implementation, the data file may comprise a spreadsheet document. In other embodiments, the data file may comprise another document type such as one generated by an accounting software comprising a plurality of data entries that may be desired to analyze. The data file may comprise a plurality of data entries, each of the data entries having a value for some or all of a plurality of criteria. In some implementations, the data file may comprise a general ledger including a plurality of transactions as data entries. It is also noted that a transaction can be reflected as a combination of multiple data entries. A combination of multiple data entries which are associated together, for example as corresponding to a same transaction, can be referred to as a “data item.” For example, one data entry may indicate a reduction in one quantity (e.g. money) and another related data entry may indicate a corresponding increase in another quantity (e.g. inventory). The two data entries together may thus indicate the transaction of acquiring inventory. In this case, the criterion may comprise: a) a transaction ID criterion or journal entry criterion ID, b) a date criterion, c) an amount criterion, d) an account criterion ID, e) an account description criterion, and f) a memo criterion, though fewer than these six criterion indications could be included and additional criterion indications could also be included. At step 604, the processing entity may be used to select features to use within outlier detection operations. Furthermore, the features are selected from or based on the data file. At step 606, the processing entity may be used to select outlier detection operations. Selecting outlier detection operations can include selecting an outlier detection algorithm and pairing it with one or more of the selected features, so that the selected outlier detection operation uses the corresponding selected outlier detection algorithm which in turn accepts and processes data entries for the one or more selected features. At step 608, the processing entity may be used to set weightings for the selected outlier detection operations within the ensemble. Furthermore, the ensemble is a combination of multiple outlier detection operations, possibly along with one or more models such as machine learning models. At step 610, the processing entity may be used to calibrate the ensemble using feedback.

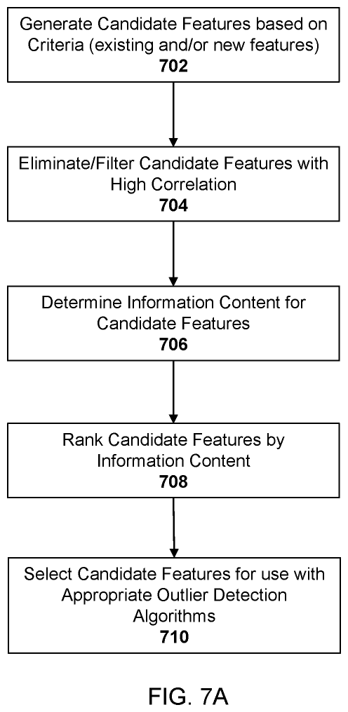

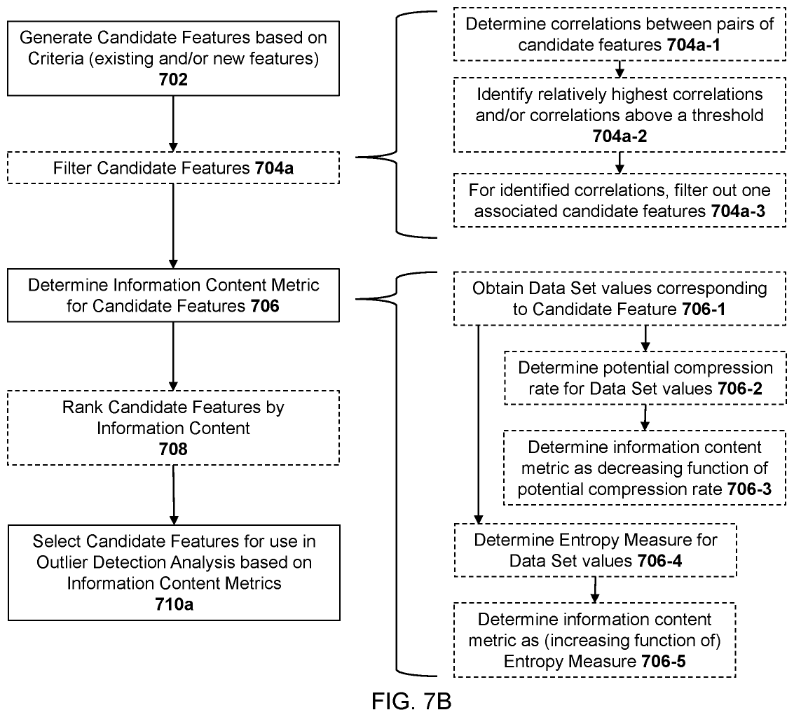

FIG. 7A is a flowchart depicting steps of a method performed using the processing entity to select features for use in the ensemble, according to an embodiment of the present invention. At step 702, the processing entity may be used to generate candidate features based on criteria in the data set. This may involve selecting candidate features from the data set, e.g. by extracting or identifying features already inherent in the data set. This may additionally or alternatively involve generating new features based on contents of the data set. At step 704, the processing entity may be used to eliminate or filter out candidate features with high correlation. For example, sets of two or more candidate features which are highly correlated with each other can be identified, and rules can be applied so that only a limited number (e.g. one or two) of the features in each set are selected for use in outlier detection operation. Such a rule can include removing one or more of the candidate features from further consideration, or implementing a selection rule that tends to avoid using multiple features from the same set in building outlier detection operations. An example of a selection rule is a rule which selects features in order to minimize a cost function, where the cost function increases when multiple highly correlated features are selected. At step 706, the processing entity may be used to determine information content in candidate features. At step 708, the processing entity may be used to rank candidate features by information content. That is, candidate features with relatively highest information content can be ranked higher, indicating that selection of these candidate features for use in outlier detection operations is to be prioritized. At step 710, the processing entity may be used to select candidate features for use with appropriate outlier detection algorithms to produce outlier detection operations. One or more of the steps in FIG. 7A can be omitted, or some of the steps can be reordered.

FIG. 7B is a flowchart depicting steps of a method performed using the processing entity to select features for use the ensemble, according to another embodiment of the present invention. Again at step 702, candidate features of the data set are selected, generated, or both. As illustrated in FIG. 1, features, and thus candidate features, include data set criteria or else relationships between criteria. A candidate feature thus corresponds to certain values of data entries, specifically values of data entries within criteria which correspond to the candidate feature. Step 704a, which may be included or omitted, includes filtering the candidate features, for example based on information content, correlation, etc. Step 706 includes determining an information content metric for each candidate feature. More specifically, for each candidate feature, the information content metric may be determined based on values of the data entries within the criteria which correspond to that candidate feature. The information content metric may be based on a potential data compression rate for those values, or an information theoretic (Shannon) Entropy for those values. Step 708, which may be included or omitted, includes ranking the candidate features according to their determined information content metrics, for example in increasing or decreasing order of information content metric values. Step 710a includes selecting one or more of the candidate features based on the determined information content metrics. The candidate features which are selected may then be used for outlier detection analysis, i.e. pair with outlier detection algorithms to produce outlier detection operations. The selection may involve selecting those candidate features with relatively highest information content metric, or information content metric above a predetermined threshold, or a combination thereof.

The filtering 704a of candidate features may involve determining 704a-1 correlations between pairs of candidate features. The filtering may further involve identifying 704a-2 the correlation values which are the highest compared to the others (e.g. the top 10% of values) and/or the correlation values which are above a predetermined threshold. The filtering may further involve, for such high correlation values, filtering out (i.e. removing from the pool of candidates) at least one of the pair of candidate features associated with each such correlation value.

Determining 706 the information content metric for a candidate feature can include obtaining 706-1 the data set values corresponding to that candidate feature, i.e. as extracted from the corresponding criteria. The determining can further include determining 706-2 a potential compression rate for the obtained data set values, for example via computation or by compressing the data. The information content metric can then be determined 706-3 based on the potential compression rate, i.e. as a decreasing function so that higher potential compression rates correspond to lower information content. Additionally or alternatively, determining 706 the information content metric can include, after operation 706-1, determining 706-4 an entropy measure for the data set values, for example as described elsewhere herein. Then, the information content metric can then be determined 706-5 based on the entropy measure, i.e. equal to or as an increasing function so that higher entropy corresponds to higher information content.

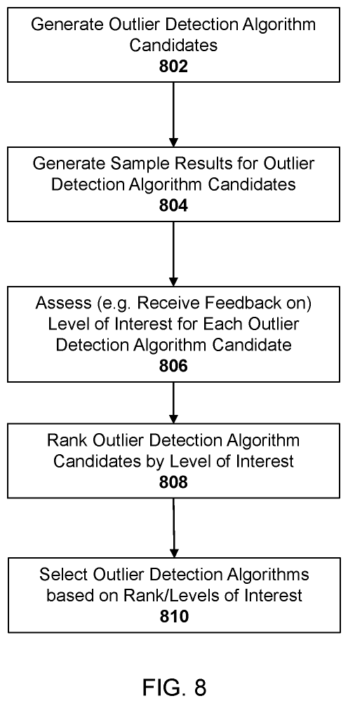

FIG. 8 is a flowchart depicting steps of a method performed using the processing entity to select outlier detection algorithms used to generate the ensemble according to an embodiment of the present invention. At step 802, the processing entity may be used to generate outlier detection algorithm candidates. This may involve selecting a subset of all possible outlier detection algorithms according to criteria, such as data set content, type of outlier, etc. At step 804, the processing entity may be used to generate sample (preview) results for the outlier detection algorithm candidates. This may involve operating the outlier detection algorithms on part of the data set, in particular on appropriately selected features. The generated results can be processed, for example to determine whether they exhibit a favourable or promising characteristic of detecting potential outliers. This may involve determining whether the generated results provide useful scoring of data entries as outliers, with a useful distribution in the scoring. At step 806, the processing entity may be used to assess a level of interest in the outlier detection algorithm candidates. This may involve receiving operator feedback indicative of level of interest. The level of interest and operator feedback may be generated based on the sample results. At step 808, the processing entity may be used to rank the outlier detection algorithms by the level of interest. The level of interest may be based at least in part on user or user input. The level of interest may be based at least in part on information content, correlations, effectiveness metrics, diversity metrics, availability of appropriate features for sue with the algorithms, test runs, etc. At step 810, the processing entity may be used to select the outlier detection algorithms for use in the ensemble, based on the ranks and/or levels of interest.

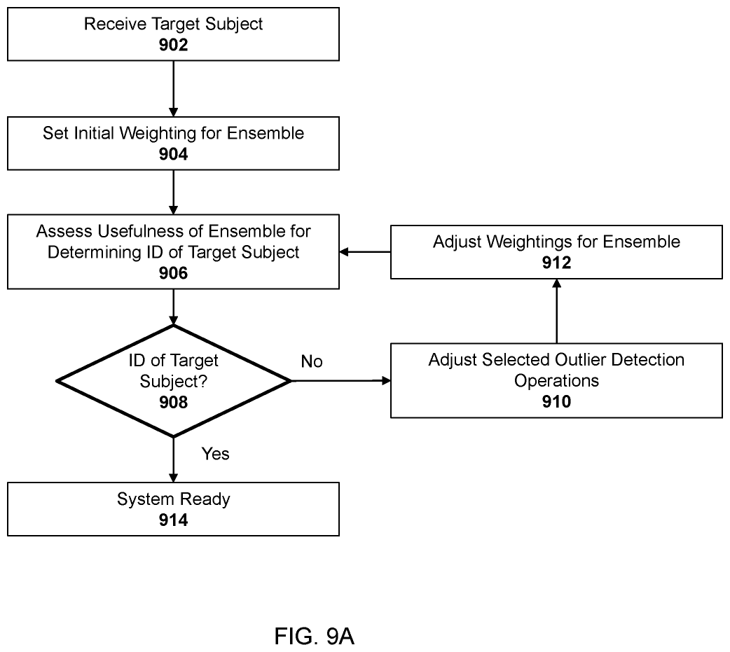

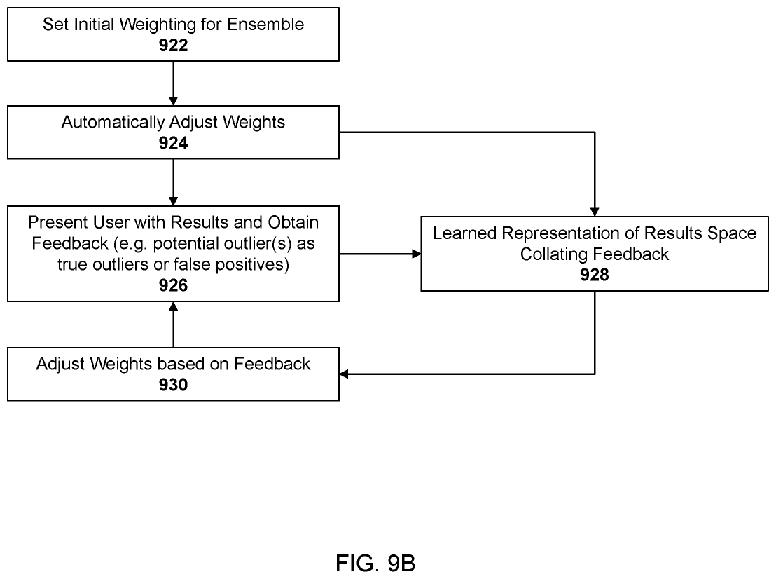

FIG. 9A is a flowchart depicting steps of a method performed using the processing entity to adjust the ensemble according to an embodiment of the present invention. At step 902, the processing entity may be used to receive a target subject. The target subject may correspond to an overall goal for the outlier detection. The target subject may be an outlier or outliers to be identified. The overall goal for outlier detection may be to tune an ensemble (e.g. by adjusting weights) for example to maximize, as much as is feasible considering other constraints, an outlier detection score when applied to the target subject. For example, the target subject may indicate whether an ensemble meets its objective by adequately identifying outliers, where the identified outliers are those that are of interest for the overall exercise. At step 904, the processing entity may be used to set an initial weighting for the ensemble. At step 906, the processing entity may be used to assess the usefulness score for an ensemble score, in relation to the target subject. The assessment may also involve obtaining input from an operator, for example indicating the extent to which the operator agrees with a sample of detected outliers and/or non-outliers. At a step 908, the processing entity may be used to determine the ID of the target subject. If the ID of the target subject is not determined at step 908, the processing entity may be used to adjust selected outlier detection operations of the ensemble, at step 910 and adjust weighting for the ensemble, at step 912. The processing entity may be used to further assess the usefulness of the ensemble score for the target subject after step 912. If the ID of the target subject is determined at step 908, then the system is determined to be ready for use in processing the data set, at step 914.

FIG. 9B is a flowchart depicting steps of a method performed using the processing entity to configure the weights in the ensemble using user feedback, according to an embodiment of the present invention.

At step 922, an initial (e.g. default) set of ensemble weights is set using an initial state method. For example, in the initial state all weights may be equal or certain weights may be higher or lower due to known general effectiveness of outlier methods present in the ensemble.

At step 924, the weights in the ensemble are adjusted from default/initial state based on an automatic calibration which uses each algorithm's effectiveness or diversity assessment to adjust the initial weights. For example, sets of two or more candidate features which are highly correlated with each other can be identified, and rules can be applied so that only a limited number (e.g. one or two) of the features in each set are selected for use in outlier detection operation. Such a rule can include removing one or more of the candidate features from further consideration, or implementing a selection rule that tends to avoid using multiple features from the same set in building outlier detection operations. Other considerations, such as information content metrics and/or effectiveness metrics may also be used in this step. An example of a selection rule is a rule which selects features in order to minimize a cost function, where the cost function increases when multiple highly correlated features are selected.

At step 926, a user feedback process is used where users are presented with results showing a ranking of outlier scores generated using the current ensemble, for a data set or a portion of the data set, or a test data set. The user can review the results and, using their judgement, assess if the outlier detected is desired to have the ranking which it currently has. In some embodiments, users may look at outliers which received high, medium or low outlier scores. If the user disagrees with the ranking they can indicate if they would prefer the ranking to be lower or higher for an individual item, this could be indicated for example with a ‘thumbs up’ or ‘thumbs down’ user gesture indicating agreement or disagreement with a presented ranking, or another indication of user agreement/disagreement with proposed results.

At step 928, the results of the user feedback are brought together and multiple sets of feedback from multiple users may be considered. Through a process of machine learning using an operation such as logistic regression or a neural network, a reweighting calibration can be obtained by learning from the user feedback.

At step 930, the results from learning from user feedback in step 928 can be applied to adjust the ensemble weightings and all outlier scores can be recomputed using the new adjusted weightings. The process can then repeat from step 926, and new user feedback can be received. This procedure can be used as a part of constructing the ensemble initially but can also be used over time to continually adjust and improve weightings.

In various embodiments, in an iterative process, all entries in a data set are scored using a current ensemble. The scores indicate that some data entries are potentially outliers of interest. An operator is presented with at least some of these outliers of interest and feedback is obtained as to whether the operator agrees that they are in fact outliers. The weightings for the ensemble and/or other aspects of the ensemble are then adjusted based on the feedback. For example, the weightings can be adjusted up or down for each algorithm depending on whether that algorithm tended to identify true outliers or false positives. This process can be performed multiple times iteratively until the ensemble is adequately tuned. Notably, the operator does not necessarily know what outliers might exist in the data set a priori, and the data entries are not labeled, so the process is an iterative calibration.

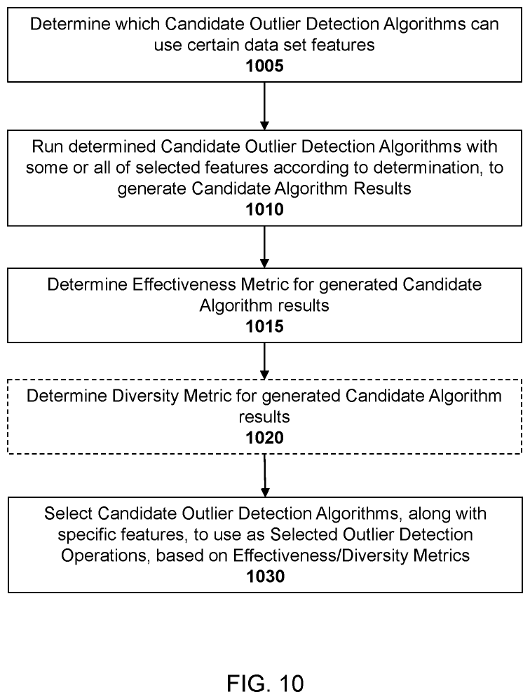

FIG. 10 illustrates operations for selecting outlier detection operations, according to an embodiment. The operations include determining 1005 which of a given set of candidate outlier detection algorithms can use certain features of the data set, such as available features or already-selected features. This can include filtering out candidate algorithms that are not compatible with certain features, as previously described. The operations include running 1010 each one of a set of candidate outlier detection algorithm with at least some, or all, of the selected features that can be used with that candidate outlier detection algorithm. This provides for generated candidate algorithm results. This can involve testing candidate outlier detection algorithms as previously described. The operations further include determining 1015 an effectiveness metric for each of these candidate algorithm results (also as previously described). The effectiveness metric measures the ability of the candidate algorithm results to separate data entries for outlier detection. FIG. 10 further illustrates determining 1020 a diversity metric for each of the generated candidate algorithm results, and this step can be included or omitted. The diversity metric measures the correlation between information in the candidate algorithm results, and may also be as previously described. The operations further include selecting 1030 certain candidate outlier detection algorithms, along with specific features, to use as the selected outlier detection operations. This selection 1030 is based at least partially on the determined effectiveness metrics. The selection 1030 may further be based on the determined diversity metrics.

Embodiments of the present invention relate to a system or a method for building analytic AI ensembles for supporting domain-specific human decision making. Ensembles of ensembles bring specific detection value across a plurality of diverse datasets. Further to this notion, ensembles may be designed with a specific purpose in mind in order to improve predictions/detections but also to facilitate maximum reuse.

Almost every business will have multiple sources of information spanning different operational systems from finance to human resources (HR), inventory to expenses even sales practices. These sources potentially contain structured and unstructured (document) data. Connecting risk detection across business areas can be done with analytic ensembles. Each ensemble presents a specific purpose of which there can be many, and these ensembles can participate in advising business decisions and helping to detect operational risks and challenges across a variety of employee roles.

An example is now provided, in relation to audit assertions for expense analysis. An audit is a regulated activity with defined assertions that must be analyzed and met in order to pass the audit. Audits are therefore often structured around these assertions. The relevant assertions for Expense Analysis may be, for example: Occurrence—did the thing happen?; Accuracy—are related values recorded at the right amount; Classification—are related values recorded as the right type of thing?′ Completeness—has everything been recorded? Cut-Off—have the values been recorded at the right time?

Each assertion can be analyzed independently, and an ensemble can be constructed to mirror the assertions and provide a view of each assertion's risk. The process of constructing the ensemble around the audit risk assertions includes understanding the given assertion and constructing or configuring algorithms to detect the various indicators. For example, classification error is susceptible to being detected using a combination of the following method questions: 1) Does the amount of the transaction appear in the normal range for transactions in the same class? (Algorithm Detect Outlier by Account); 2) Does the timing of the transaction match normal timing for similar class transactions? (For transaction class Detects Unusual Timing, Day of Month or Day of Year, etc.) 3) Is the transaction submitted by the normal business process for transactions of this class? (Detect User, Process or Business Function, or T-code)?; 4) Does the transaction description conflict with the classification or indicate a different classification is more appropriate?; 5) Does the transaction contain the right combinations of accounts for this class? (Detect unusual transaction account mix); 6) Is a prior classification in doubt, as time has passed of more recent transactions/information indicate the classification is now in doubt?

According to embodiments of the present invention, there is provided method for building ensembles that, through combining technical algorithms and business specific objectives, can create a tailored set of ensembles. The ensembles are susceptible to providing a risk-based view with an explanation of each detected risk. Each ensemble that is targeted to a business purpose can be built and tuned using the ensemble builder.

Embodiments of the present invention provide a systematic way to link sets of ensembles to a specific business or regulatory risks. Connecting risks areas to specific algorithms are susceptible to support the given objective.

Although outlier identification is introduced above as a motivating application, it is recognized that ensembles of algorithms/operations can be generated for other purposes. Toward this end, the concept of an outlier can be extended to encompass, for example, data entries which are of interest in a certain manner. The interest may be associated at least partially with a predetermined characteristic or feature, at least partially with a characteristic or feature which becomes evident through processing and/or interaction with the data, or a combination of the above.

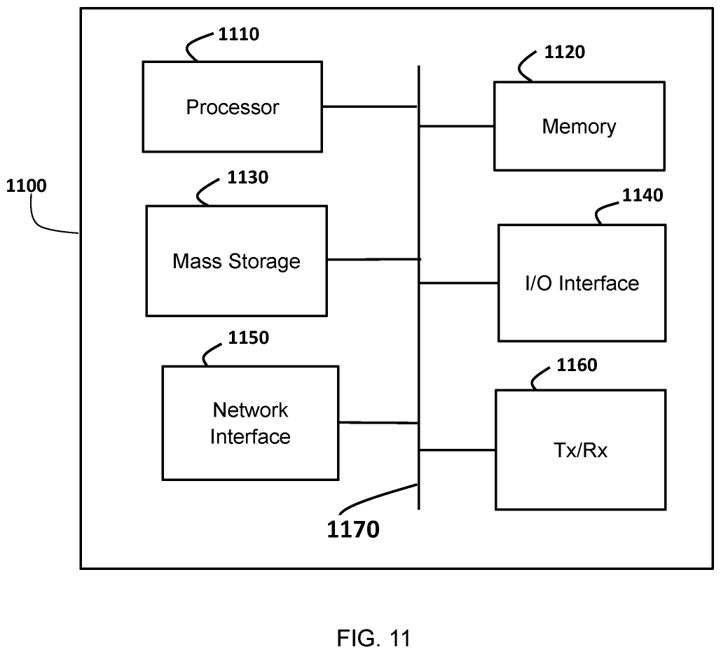

FIG. 11 illustrates an apparatus 1100 that may perform any or all of operations of the above methods and features explicitly or implicitly described herein, according to different aspects of the present invention For example, a computer may be configured as the apparatus 1100. In some aspects, the apparatus 1100 may be a computer such as a general purpose or special purpose computer. The apparatus may be a single unit or formed from distributed components, for example in a data center, or a combination thereof. The apparatus or components thereof may be virtualized. Multiple such apparatuses can be networked together to provide for embodiments of the present invention.

As shown, the apparatus 1100 may include a processor 1110, such as a Central Processing Unit (CPU) or specialized processors such as a Graphics Processing Unit (GPU) or other such processor unit, memory 1120, non-transitory mass storage 1130, input-output interface 1140, network interface 1150, and a transceiver 1160, all of which are communicatively coupled via bi-directional bus 1170. Transceiver 1160 may include one or multiple antennas. According to certain aspects, any or all of the depicted elements may be utilized, or only a subset of the elements. Further, apparatus 1100 may contain multiple instances of certain elements, such as multiple processors, memories, or transceivers. Also, elements of the hardware device may be directly coupled to other elements without the bi-directional bus. Additionally, or alternatively to a processor and memory, other electronics or processing electronics, such as integrated circuits, application specific integrated circuits, field programmable gate arrays, digital circuitry, analog circuitry, chips, dies, multichip modules, substrates or the like, or a combination thereof may be employed for performing the required logical operations.

The memory 1120 may include any type of non-transitory memory such as static random-access memory (SRAM), dynamic random-access memory (DRAM), synchronous DRAM (SDRAM), read-only memory (ROM), any combination of such, or the like. The mass storage element 1130 may include any type of non-transitory storage device, such as a solid-state drive, hard disk drive, a magnetic disk drive, an optical disk drive, USB drive, or any computer program product configured to store data and machine executable program code. According to certain aspects, the memory 1120 or mass storage 1130 may have recorded thereon statements and instructions executable by the processor 1110 for performing any method operations described herein.

Aspects of the present disclosure can be implemented using electronics hardware, software, or a combination thereof. In some aspects, this may be implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method implemented by a computing apparatus for selecting features within a data set to use for outlier detection analysis; the data set comprising a plurality of data entries, each of the data entries comprising a value for some or all of a plurality of criteria; the method comprising, automatically by the computing apparatus:
selecting a plurality of candidate features of the data set, each of the candidate features comprising or being derived from one or more of the criteria;
for each candidate feature, determining an information content metric for values of data entries within the criteria of the candidate feature; and
selecting one or more of the candidate features to be the features within the data set to use for outlier detection analysis at least partially using the determined information content metrics.

2. The method of claim 1, wherein the selecting the features within the data set to use for outlier detection analysis further comprises: prior to selecting the one or more of the candidate features, determining one or more pairwise correlations between the candidate features; and, if one of the correlations, between two of the candidate features, is above a predetermined threshold, inhibiting using both of the candidate features associated with the one of the correlations.

3. The method of claim 1, wherein the determining the information content metric for values of data entries within the criteria of the candidate feature comprises determining a potential compression rate for the values of data entries within the criteria, wherein the information content metric is a decreasing function of the potential compression rate for the values of data entries within the criteria of the candidate feature.

4. The method of claim 1, wherein the determining the information content metric for values of data entries within the criteria of the candidate feature comprises using entropy calculations on the values of data entries within the criteria.

5. The method of claim 1 further comprising:
selecting a plurality of outlier detection operations to generate an outlier characteristic metric for evaluating data entries within the data set, each of the outlier detection operations comprising an outlier detection algorithm being run with one of the selected features;
generating an outlier characteristic metric for each one of a set of data items using each of the plurality of selected outlier detection operations, wherein each one of the set of data items is one of the plurality of data entries or a set of associated ones of the plurality of data entries; and
combining the plurality of outlier characteristic metrics for said each one of the set of data items to generate an ensemble outlier metric for said each one of the set of data items.

6. The method according to claim 5, wherein the selecting the plurality of outlier detection operations comprises: determining which of a plurality of candidate outlier detection algorithms can use the selected features; running each of the candidate outlier detection algorithms with each of the selected features that can be used with the particular candidate outlier detection algorithm to generate candidate algorithm results; determining an effectiveness metric for each of the candidate algorithm results, the effectiveness metric measuring the ability of the candidate algorithm results to separate data entries for outlier detection; and selecting the plurality of candidate outlier detection algorithms with specific features to use as the selected outlier detection operations based at least partially on the effectiveness metrics for the corresponding candidate algorithm results.

7. The method according to claim 6, wherein the selecting a plurality of outlier detection operations further comprises: determining a diversity metric for each of the candidate algorithm results relative to all other candidate algorithm results, the diversity metric measuring the correlation between information in the candidate algorithm results; wherein the selecting the plurality of candidate outlier detection algorithms with specific features as the selected outlier detection operations is further based at least partially on the diversity metrics for the candidate algorithm results relative to other candidate algorithm results.

8. A computing apparatus for selecting features within a data set to use for outlier detection analysis, the computing apparatus comprising:
a processing entity operable to: receive a data set comprising a plurality of data entries, each of the data entries comprising a value for some or all of a plurality of criteria; select a plurality of candidate features of the data set, each of the candidate features comprising or being derived from one or more of the criteria; for each candidate feature, determine an information content metric for values of data entries within the criteria of the candidate feature; and select one or more of the candidate features to be the features within the data set to use for outlier detection analysis at least partially using the determined information content metrics.

9. The computing apparatus of claim 8, wherein to select the features within the data set to use for outlier detection analysis, the processing entity is operable to: prior to selecting the one or more of the candidate features, determine one or more pairwise correlations between the candidate features; and, if one of the correlations, between two of the candidate features, is above a predetermined threshold, filter one of the candidate features associated with the one of the correlations.

10. The computing apparatus of claim 8, wherein to determine the information content metric for values of data entries within the criteria of the candidate feature, the processing entity is operable to: determine a potential compression rate for the values of data entries within the criteria, wherein the information content metric is a decreasing function of the potential compression rate for the values of data entries within the criteria of the candidate feature.

11. The computing apparatus of claim 8, wherein to determine the information content metric for values of data entries within the criteria of the candidate feature, the processing entity is operable to: use entropy calculations on the values of data entries within the criteria.

12. The computing apparatus of claim 8, wherein the processing entity is further operable to: select a plurality of outlier detection operations to generate an outlier characteristic metric for evaluating data entries within the data set, each of the outlier detection operations comprising an outlier detection algorithm being run with one of the selected features; generate an outlier characteristic metric for each one of a set of data items using each of the plurality of selected outlier detection operations, wherein each one of the set of data items is one of the plurality of data entries or a set of associated ones of the plurality of data entries; and combine the plurality of outlier characteristic metrics for said each one of the set of data items to generate an ensemble outlier metric for said each one of the set of data items.

13. The computing apparatus of claim 12, wherein to select the plurality of outlier detection operations, the processing entity is operable to: determine which of a plurality of candidate outlier detection algorithms can use the selected features; run each of the candidate outlier detection algorithms with each of the selected features that can be used with the particular candidate outlier detection algorithm to generate candidate algorithm results; determine an effectiveness metric for each of the candidate algorithm results, the effectiveness metric measuring the ability of the candidate algorithm results to separate data entries for outlier detection; and select the plurality of candidate outlier detection algorithms with specific features to use as the selected outlier detection operations based at least partially on the effectiveness metrics for the corresponding candidate algorithm results.

14. The computing apparatus of claim 13, wherein to select the plurality of outlier detection operations, the processing entity is further operable to: determine a diversity metric for each of the candidate algorithm results relative to all other candidate algorithm results, the diversity metric measuring the correlation between information in the candidate algorithm results; wherein the selecting the plurality of candidate outlier detection algorithms with specific features as the selected outlier detection operations is further based at least partially on the diversity metrics for the candidate algorithm results relative to other candidate algorithm results.

15. Non-transitory computer-readable media containing a program element executable by a computing system to perform a method for selecting features within a data set to use for outlier detection analysis; the data set comprising a plurality of data entries, each of the data entries comprising a value for some or all of a plurality of criteria; the method comprising:
selecting a plurality of candidate features of the data set, each of the candidate features comprising or being derived from one or more of the criteria;
for each candidate feature, determining an information content metric for values of data entries within the criteria of the candidate feature; and
selecting one or more of the candidate features to be the features within the data set to use for outlier detection analysis at least partially using the determined information content metrics.

16. The non-transitory computer-readable media of claim 15, wherein the selecting the features within the data set to use for outlier detection analysis further comprises: prior to selecting the one or more of the candidate features, determining one or more pairwise correlations between the candidate features; and, if one of the correlations, between two of the candidate features, is above a predetermined threshold, inhibiting using both of the candidate features associated with the one of the correlations.

17. The non-transitory computer-readable media of claim 15, wherein the determining the information content metric for values of data entries within the criteria of the candidate feature comprises determining a potential compression rate for the values of data entries within the criteria, wherein the information content metric is a decreasing function of the potential compression rate for the values of data entries within the criteria of the candidate feature.

18. The non-transitory computer-readable media of claim 15, wherein the determining the information content metric for values of data entries within the criteria of the candidate feature comprises using entropy calculations on the values of data entries within the criteria.

19. The non-transitory computer-readable media of claim 15, wherein the method further comprises:
selecting a plurality of outlier detection operations to generate an outlier characteristic metric for evaluating data entries within the data set, each of the outlier detection operations comprising an outlier detection algorithm being run with one of the selected features;
generating an outlier characteristic metric for each of a set of data items using each of the plurality of selected outlier detection operations, wherein each one of the set of data items is one of the plurality of data entries or a set of associated ones of the plurality of data entries; and
combining the plurality of outlier characteristic metrics for said each one of the set of data items to generate an ensemble outlier metric for said each one of the set of data items.

20. The non-transitory computer-readable media of claim 19, wherein the selecting the plurality of outlier detection operations comprises: determining which of a plurality of candidate outlier detection algorithms can use the selected features; running each of the candidate outlier detection algorithms with each of the selected features that can be used with the particular candidate outlier detection algorithm to generate candidate algorithm results; determining an effectiveness metric for each of the candidate algorithm results, the effectiveness metric measuring the ability of the candidate algorithm results to separate data entries for outlier detection; and selecting the plurality of candidate outlier detection algorithms with specific features to use as the selected outlier detection operations based at least partially on the effectiveness metrics for the corresponding candidate algorithm results.

21. The non-transitory computer-readable media of claim 20, wherein the selecting a plurality of outlier detection operations further comprises: determining a diversity metric for each of the candidate algorithm results relative to all other candidate algorithm results, the diversity metric measuring the correlation between information in the candidate algorithm results; wherein the selecting the plurality of candidate outlier detection algorithms with specific features as the selected outlier detection operations is further based at least partially on the diversity metrics for the candidate algorithm results relative to other candidate algorithm results.
